(19) United States
(12) Patent Application Publication
(10) Pub. No.: US 2025/0250460 A1
(43) Pub. Date: Aug. 7, 2025

(54) COATING KIT AND METHOD FOR REPAIR AND/OR RECONSTITUTION OF RUBBER AND/OR METAL WORN AREAS

(71) Applicant: BERTECH PANAMÁ S.A., Ciudad de Panamá (PA)

(72) Inventors: Marco PICON BERNIER, Santiago (CL); Francisco PICON BERNIER, Santiago (CL); Pedro LANG, Santiago (CL)

(21) Appl. No.: 18/855,767

(22) PCT Filed: Sep. 8, 2022
(86) PCT No.: PCT/IB2022/058485

§ 371 Date: Oct. 10, 2024

(51) Int. Cl. C09D 175/12; C09D 5/00; C09D 7/20; C09D 7/40; C09D 7/43; C09D 7/62; C09D 7/65; C09D 133/04; C09D 161/04; C09D 167/00

(52) U.S. Cl. CPC C09D 175/12; C09D 5/002; C09D 7/20; C09D 7/43; C09D 7/62; C09D 7/65; C09D 7/70; C09D 133/04; C09D 161/04; C09D 167/00

(57) ABSTRACT

The coating kit or system described by the present invention belongs to the group of components used for lining and coating metal surfaces, as well as for reconstitution and recovery of worn natural or synthetic rubber surfaces. Said kit or chemical coating system allows for a fast and long-lasting cold repair and/or reconstitution of rubber and/or metal worn areas, having the great advantage of being applicable on horizontal, vertical and tilted surfaces. The coating kit for repair and/or reconstitution of rubber and/or metal worn areas, comprising: * component A, main resin; * Component B, hardener, * component C, comprising: (i) up to 10% of a rubber oxidative primer adhesive and (ii) up to 99.5% of at least a solvent; * component D, metal primer adhesive; and * component E, oxygenated and/or hydrocarbon cleaning solvent. The present invention further claims a method for coating a worn rubber and/or metal surface; the use of the coating kit for coating equipment subjected to high wear; and a metal primer adhesive component, which is part of the coating kit for repair and/or reconstitution of rubber and metal worn areas.

The present invention belongs to the technical field of protecting equipment exposed to wear; wherein rubber or polyurethane coatings are used for repair and/or reconstitution of rubber and/or metal worn areas; more particularly, this invention relates to a flexible coating kit or system applicable to horizontal, vertical, tilted surfaces and overhead of an operator, for repair and/or reconstitution of worn rubber and/or metal surfaces. Further, this invention further relates to the use of the equipment coating kit and the method of coating a worn surface. In particular, the invention is further directed to a metal primer adhesive component, which is also part of the kit.

### BACKGROUND OF THE INVENTION

In general, any defect of any equipment involved in the production process will have a negative impact on production, so becomes vital to have a continuous production rate across the entire industrial sector so as to obtain good business profitability. Some of this equipment may be, without limitation, large earth excavators, conveyor belts, pulleys, drums, hydrocyclones, grinding equipment, pumps, pipes and valves, which are often exposed to a wide spectrum of product deterioration from abrasion, impact and corrosion effects. Industrial plant maintenance personnel is constantly working to prevent and fix these problems using different protection methods, being required, in some extreme cases, replacement of some parts or the entire equipment for subsequent repair or disposal.

Consequently, various protection systems are currently in use, including the use of coatings having different mechanical features, applicability, durability, speed of application and efficiency. Epoxy, polyurethane, natural rubber, ceramic or special steel plates are typically used for protecting surfaces exposed to wear. All these solutions have advantages and disadvantages. For example, applying rubber or polyurethane coatings by means of high-temperature vulcanization process, using an autoclave, is a methodology typically used. Although this procedure is highly reliable, disadvantageously requires large specialized repair shops to be carried out and several hours to complete.

Another widely used methodology for protecting industrial equipment is putting cold-bonded vulcanized rubber patches, using several layers of special adhesive or cements for binding the vulcanized rubber pieces on a rubber or metal substrate. However, applying said adhesives requires adequate specificity and a complex process, since this procedure is carried out in distinct steps, which take a lot of time because adhesive has to dry, resulting in a limited adherence, in most cases. Although this type of methodology could be carried out in situ for less severe and very specific cases, typically its implementation require removing and transporting the equipment in operation to large repair shops for removing the old coating and putting on the new coating. The above results in considerable loss of production due to the impossibility to restart equipment operation in short term.

On the other hand, wear resistant steel plates or ceramic pads can also be used for protecting industrial equipment on metal surfaces against abrasion and/or impact. Wear resistant steel plates are typically welded or bolted onto metal structures to receive the impact or abrasive wear in place of the original structure. This type of solution extends equipment useful life but has the disadvantage of requiring sizing the plates before mounting them on each industrial equipment, and are not efficient to be used on flexible surfaces such as a natural rubber substrate because none of them is flexible. Additionally, this solution does not allow recovering the original plate thickness as it wears out by abrasion. This problem also occurs when ceramic pads are used to protect equipment against abrasion. Said pads should be particularly sized for each piece of equipment, typically mounted in a repair shop outside the production lines, do not support impact and their thickness cannot be recovered as they wear. Similarly, as metal plates, ceramic pads cannot be used for coating rubber substrates subjected to impact, such as conveyor belts, since these pads would break easily.

In the case of the application of epoxy or polyurethane resins for protecting industrial equipment, the state-of-the-art analysis should be separated into two main groups:
i) Application of coatings on rubber surfaces (flexible substrate); and
ii) Application of coatings on metal surfaces (rigid substrate).
i) Application of coatings on rubber surfaces. Rubber surfaces are typically found in both industrial equipment made of this material, such as conveyor belts used in mining, or as protective coating. Original rubber both of conveyor belts and structural coatings undergoes wear by abrasion, impact or external chemical agents. Polyurethane resins are generally used for repairing, coating, covering or filling rubber substrates, said resins are used for cold reconstitution or recovery of natural rubber surface wear. Said resins can also be applied on these substrates (rubber) as a preservative to protect against damage caused by oxidation or other corrosive agents. However, said state-of-the-art formulations comprising polymer resins differ from the present invention in the following aspects:
   Some resins incorporate a plasticizer, which causes a decrease in the physical properties of the polymer resin, mainly on those having a polyurethane-based formulation. Said polyurethane, a component of the formulation, not only loses hardness and elongation physical characteristics by the use of a plasticizer product, but its physical storage condition is also affected, since polymer resin solidifies at temperatures below 20° C. after seven days from manufacture. This problem forces the user to heating the resin to return it to its original liquid or pasty state so it may be applied on the rubber surface to be repaired, thus increasing repair time.
   Another technical problem seen in the state-of-the-art coating formulations is the liquid or pasty, non-thixotropic consistency of polymer resins, which makes said resins very difficult to apply on tilted and/or vertical surfaces, because said formulation runoff due to the effect of gravity.
   In the case of epoxy-based resins, said resins are typically used to bond to metal substrates, since adequate adhesion to rubber is very difficult to achieve at room temperature and, if possible, a formulation of this kind would be economically non-viable. On the other hand, a flexible epoxy formulation for binding onto rubber would have a lower abrasion resistance than a polyurethane solution.
ii) Application of coatings on metal surfaces. Both epoxy and polyurethane coatings may be used for metal surface coatings. Epoxy technologies are widely used in situations where metal structures are to be protected against wear, having a very good performance. However, the main problem with these technologies is that the coatings are rigid having high hardness and little flexibility, which is not suitable for a coating in some situations; for example, for pulleys used in a conveyor belt system. Pulleys are typically equipment having an original rubber coating bound to its metal structure through hot vulcanization. This rubber coating is necessary for the pulley to have good traction for moving a conveyor belt loaded with tons of material. Typically, the original rubber coating of said pulleys may detach therefrom, forcing to stop and remove the pulleys from the conveyance equipment, before taking them to the repair shop for subsequent coating by applying prefabricated rubber sheets, which should be cut and sized according to the damaged area to be repaired, to be later bound using two layers of adhesive cement. Eventually, an epoxy-based coating could be used as a temporary measure for repairing pulleys; however, said alternative has the disadvantage of mixing two materials with very different mechanical characteristics, i.e., a rigid epoxy-type coating with a flexible rubber-type coating, which would cause misalignment of the conveyor belt and early wear of the conveyor system. Therefore, this alternative could not be considered as a definitive, reliable or long-lasting repair.

Finally, another problem not solved by the current available solutions is the application of a flexible coating that firmly and uniformly cold bound in situ at room temperature, when both substrates are present, i.e., rubber and metal concurrently. An exemplary situation is having an area of the original rubber coating of an ore conveyor system pulleys detached, the damage is located where the two different substrates are present: metal, where the coating is detached, and rubber, at the edges of the damage, contiguous with the rest of the original coating that has not detached. Another example of a situation where coating is required on both substrates (rubber and metal) is steel cord conveyor belts, which can undergo such deep damage to their covers that steel cords are exposed to the surface.

In these circumstances, the already known coating formulations comprising polymer resins are not able to provide a solution allowing a firm and uniform adherence for both substrates (rubber and metal), thus causing that several points repaired with these polymers do not have a suitable adhesion, by either lacking of adhesion to rubber, or adhesion to metal, which will ultimately cause partial or total detachment of a reparation made with these polymers. Faced with this problem, the only option will be to change sections of the belt having exposed steel cords, or repairing them using hot vulcanization; both cases have the inconvenience of not being a fast repair, since these the procedures would take more than twelve hours of work, substantially decreasing production and increasing industrial economic cost. As may be concluded from the previous cases, there is a need for a flexible system that can bound to both original rubber coating and metal substrate part of the equipment structure.

In particular, there are state-of-the-art documents that disclose and protect cold-set compositions for polyurethane coating, most of them based on toluene diisocyanate, a solvent and a catalyst, mainly aromatic polyamine. Additionally, most of said documents further disclose a plasticizer.

U.S. Pat. No. 5,688,892, for example, describes a process for producing a waterproof, cold-setting, curable polyurethane coating. The isocyanate-terminated prepolymer composition comprises the reaction product between toluene diisocyanate (TDI) and a polyoxypropylene polyol and/or polyoxyethyl propylene polyol, mixed in situ with a curing agent containing a crosslinkable aromatic polyamine composed of diethyltoluenediamine and a plasticizer. However, it has the disadvantage of using a plasticizer, which, as stated above, decreases the physical properties of the formulation base component and, in addition, promotes the solidification of the resin at low temperatures, so it does not remain in liquid state for periods that would enable the application of the product.

In another case, patent EP 2970555 discloses a resin comprising a mixture of plasticizers and solvents, which alters the original characteristics of the prepolymer. In addition, said resin has a liquid consistency, which makes impossible applying on vertical or tilted surfaces. On the other hand, it uses a hydrophilic fumed silica that generates low stability in the resin, causing the resin to harden when being packaged or preserved over time. In addition, EP 2970555 does not solve the problem of coating rubber and metal surfaces, such as in the case of damaged conveyor belts having steel cords exposed.

Japanese patent JP 9176569 describes an extended-life cold-setting curable polyurethane coating, the polyurethane material is obtained by mixing a terminal-isocyanate prepolymer, comprising the product of the reaction between toluene diisocyanate (TDI) and a polyol, an aromatic polyamine crosslinking agent, a plasticizer-containing curing agent, and an inorganic filler. Presence of a plasticizer once again reduces the intrinsic properties of the formulation base component, and affects composition versatility and applicability features provided by its paste texture, despite the indicated long life.

Patent applications JP 10017820 and JP 10046103 disclose a composition made with two cold-curable components for a waterproof polyurethane coating comprising a main terminal-isocyanate prepolymer compound obtained by reacting toluene diisocyanate (TDI) and a polyol, and a curing agent, composed mainly of an aromatic polyamine. JP 10017820 states that said curing agent is composed of 30-95 mol % of diethyltoluenediamine and 70-5 mol % of amine. Meanwhile, JP 10046103 discloses a tetraalkyldiaminodipentylmethane or the mixture of 10% or more of tetraalkyldiaminodipentylmethane, and 90% or less of diethyltoluenediamine. However, product application is limited to applications where the use of a paste consistency is feasible.

On the other hand, Chilean patent CL 51,001 discloses a composition for reconstitution and recovery of natural or synthetic rubber worn surfaces, or as a preservative against oxidation or other corrosive agents, which has a liquid consistency at room temperature. The composition consists of: a) a base composition comprising: (i) 74-87% of polyurethane prepolymer; (ii) 0.1-23% of solvent; (iii) 0.1-5% pigment suitable for use in polyurethane-containing compositions; and b) a catalyst. Liquid consistency makes its use impractical for applications overhead or on tilted surfaces and, additionally, it lacks adherence to metal surfaces.

Finally, Chilean patent application CL 200703279 discloses a useful preparation for reconstitution or recovery of natural rubber worn surfaces, which comprises a crosslinkable polyurethane prepolymer or diphenylmethane diisocyanate, mixed with a diethylene glycol dibenzoate-based plasticizer in a ratio of less than 20% and catalyzed with diethylmethylbenzenediamine. However, toluene and plasticizer are used in the composition, and the product is not fluid, thus limiting its action field. Furthermore, as mentioned above, the product protected by CL 200703279 requires heating prior to application, curing time is four times longer, which is inconvenient because it requires additional time for making the composition and requires longer waiting times before reusing the equipment after being repaired.

Thus, there is a real and urgent need to have a flexible coating kit or system that simultaneously manages to solve the following aspects:

1. Keeping the resin pasty and stable at lower temperatures than current solutions.

2. Coating manually prepared and applied in situ.

3. Not use of a plasticizer to avoid altering the physical capabilities of polyurethane, avoiding loss of hardness and elasticity.

4. Capable of being applied at room temperature without requiring the resin to be heated.

5. Capable to recover the thickness of previous repairs made with the resin itself (recap)

6. Capable of being applied on horizontal, tilted and overhead surfaces, without run-off.

7. Capable of being applied as a flexible and cold coating, both on rubber and metal substrates, with excellent adhesion.

8. Fast application without the need to dismantle the equipment to take to a repair shop

9. Protect metal industrial equipment and its rubber or polyurethane coatings against wear due to abrasion, impact, compression, stretching or corrosion

Therefore, the present invention succeeds in solving the above listed problems, introducing technical and economic advantages highly desired and valued in the industrial sector, such as:
Coating manually prepared and applied in situ.
Industrial equipment maintenance costs can be reduced and coating application is easy.
Coating can be applied on horizontal, vertical, tilted surfaces and overhead of an operator
Coating application having high adherence on natural or synthetic rubber and metal substrates.
Specific damages in worn areas may be repaired, allowing preventive and corrective maintenance, without the need to remove equipment.
Fast coating application and curing (1 hr at 23° C.), reducing downtime and increasing productivity
Industrial equipment useful life is extended
Storage and application system is stable through a wide temperature range
Accident risks are reduced.

### SUMMARY OF THE INVENTION

The coating kit or system described by the present invention belongs to the group of components used for lining and coating metal surfaces, as well as for reconstitution and recovery of worn natural or synthetic rubber surfaces. Said kit or chemical coating system allows for a fast and long-lasting cold repair and/or reconstitution of rubber and/or metal worn areas, having the great advantage of being applicable on horizontal, vertical and tilted surfaces. All the above characteristics are not achieved by any type of coating known in the state-of-the-art.

Particularly, the present invention protects a coating kit for repair and/or reconstitution of rubber and/or metal worn areas, comprising:
component A, main resin: base composition comprising: (i) up to 90% of a polyurethane prepolymer having free isocyanate groups; (ii) up to 25% solvents; (iii) up to 35% of at least a pigment; and (iv) up to 10% of at least an additive;
component B, hardener: mixture comprising (i) up to 90% of at least a monomeric/polymeric aromatic polyamine, (ii) up to 50% of at least a solvent, (iii) up to 35% of a pigment and (iv) up to 35% additives;
component C, comprising: (i) up to 10% of a rubber oxidative primer adhesive (oxidative primer adhesive for rubber), which is selected between an organic oxidant and an inorganic oxidant; wherein the organic oxidant is selected from hydantoins and organic peroxides; and wherein the inorganic oxidant is selected from mono-, di- and trichloroisocyanuric, hydrogen peroxide, ammonium/sodium/potassium persulfate and chlorine dioxide; and (ii) up to 99.5% of at least a solvent;
component D, metal primer adhesive (primer adhesive for metal), which comprises a thermosetting bicomponent (DB) or a thermoplastic monocomponent (DM), wherein the thermosetting bicomponent is composed by the first component (DB1) comprising: (i) up to 95% of at least a solvent; (ii) up to 5% of at least a pigment; (iii) up to 5% of at least an additive; (iv) up to 25% of a thermoplastic resin, which is selected from phenoxy resin, polyester resin, nitrocellulose resin, CAB/CAP resin, polyurethane resin, phenolic resin, resorcinol resin, methacrylic resin, vinyl resin, polyamide/polyamine resin; and (v) up to 10% of an epoxy resin, which is selected from epoxy-ester resin, epoxy-ether resin, epoxy-amine resin, epoxy hydrocarbon/olefin resin, epoxy heterocyclic resin; and a second component (DB2) comprising: (i) up to 90% of at least a solvent; (ii) up to 5% of at least an additive; (iii) up to 15% of functional (monomeric, polymeric) resins, wherein the functional resin is at least a polyamine, or at least a polysulfide; and where the monocomponent thermoplastic primer (DM) comprises (i) up to 95% of at least a solvent, (ii) up to 5% of at least a pigment, (iii) up to 5% of at least an additive, (iv) up to 15% of high molecular weight thermoplastic resins selected from epoxy resin, phenoxy resin, polyester resin, nitrocellulose resin, CAB/CAP resin, polyurethane resin, resorcinol resin, methacrylic resin, vinyl resins, polyamide resin; and (v) up to 15% of at least a functional (monomeric, polymeric) resin, wherein the functional resin is at least a polyamine, or at least a polysulfide; and
component E, oxygenated and/or hydrocarbon cleaning solvent.

The present invention further claims a method for coating a worn rubber and/or metal surface; the use of the coating kit for coating equipment subjected to high wear; and a metal primer adhesive component, which is part of the coating kit for repair and/or reconstitution of rubber and metal worn areas.

### DETAILED DESCRIPTION OF THE INVENTION

The following definitions are provided for a better understanding of the present invention, these should only be understood as elements that help to better understand the particular technical features in this technical field:

Kit: corresponds to and is understood as a system of different chemical coating components for repair and/or reconstitution of rubber and/or metal worn areas, applicable on horizontal, vertical and tilted surfaces, wherein each chemical component is arranged in independent containers capable of interacting with each other at the time of application.

Rubber substrate: refers to typically rubber coatings used in the industry, comprising elastomers (rubber) made of polymers such as Styrene-Butadiene (SBR), Acrylonitrile-Butadiene (NBR), Butyl (IIR) and others. Fillers, accelerants, vulcanizers, etc., in addition to polymers, are also used to produce elastomer or rubber at the appropriate temperature and pressure for its vulcanization (liquid rubber hardening reaction via chemical crosslinking). Different rubbers are used by extractive industry companies, which have specific characteristics for each type of situation.

Metal substrate: refers to the metal surface on which a coating or sheet of different material is deposed. The main metal substrates are made up of common steel, alloy steels such as stainless steel, coated steels such as galvanized, steels having surface heat treatment, steels with different roughness/smoothness, aluminium, etc. The main component of common steel is iron and it may be modified with the additive element carbon for making high-carbon (0.5-2.11%), medium-carbon (0.2-0.49%) and low-carbon (0.05-0.2%) steel. Alloy steel also uses iron as the greatest component and may be classified as low-alloy (less than 5% additive elements), medium-alloy (5 to 12% additive elements), and high-alloy (more 12% additive elements) steel. The most commonly used additive elements (metals) in alloy steel are nickel, chromium, molybdenum, vanadium, tungsten, silicon, manganese, sulfur, and phosphorus. Steels with different properties, such as: greater thermal, abrasion, corrosion and mechanical resistance, hardness, impact, ductility, reduced weldability and deoxidation, are produced depending on the relative composition of iron and additive elements.

Belt Conveyor: Refers to equipment used when relatively large quantities of materials should be moved between specific positions on a fixed route. Most of these systems are mechanically driven; some use gravity to move load between points of different height.

In the technical field of protection and repair of equipment having rubber and/or metal surfaces highly exposed to wear, particularly in those equipment where rubber (natural or synthetic) or polyurethane coatings are used, a latent and inevitable condition arises, which is the need for repair and/or reconstitution of rubber and/or metal worn areas. Thus, there is a need to provide for a set of appropriate elements for reducing, so far, the excessive downtimes-either for scheduled maintenance or unexpected failure-needed for repair or maintenance of equipment having rubber and/or metal worn areas. In addition, there is a need to provide for a set of elements allowing in situ reparation of equipment that has undergone a failure due to wear of surface material, so that the spatial layout of the area to be repaired not be an obstacle for implementing the work, i.e., it shouldn't matter if the surface is horizontal, vertical, tilted, or facing the floor (looking down).

It is well known throughout the industrial sector that all those unscheduled repairs of industrial equipment are an unpleasant setback for the production process, since urgent repair actions that require the shortest possible time to put the equipment back into operation should be taken. Likewise, scheduled maintenance tasks and times are essential to maintain the productivity not only of the equipment, but of the entire company. Therefore, a set of elements that allow effective repair in the shortest possible time and hopefully in the same place, without having to resort to major equipment disassembly, is required. In addition, having a set of elements for scheduled maintenance that may be trusted to guarantee that the maintenance time is the time actually scheduled, is required.

For the particular case of this invention, and as already stated, the protection of equipment exposed to wear is carried out by means of rubber or polyurethane coatings. For conveyor belts, for example, the wear characteristics are greater due to the impact of large stones, which generates breakage, hole formation, tears and abrasive wear on surfaces. So, the conveyor belt, due to its shape and working conditions, should be flexible and somehow also resistant to impact and abrasive wear. Rubber conveyor belts or rubber surfaces are widely used in mining, metallurgical and coal industries, for conveying sandy or packaged materials.

Both fabric core and steel cord rubber conveyor belts, either high-impact or low-impact, or feeding belts, are exposed to damage and cracks resulting in the stop of production lines, causing production losses. Therefore, conveyor belts should be coated to be protected from external attacks, typical of their operation. This equipment undergoes wear and its original coatings may be damaged or even disappear, exposing the equipment casings. In these cases, it is also essential to restore equipment protection or rebuild the original rubber coatings.

Thus, in order to extend the operational durability of the equipment, it is necessary to have a chemical system that allows repairing or coating this equipment in situ, through a fast application process at room temperature, either by repairing its original rubber coating or its metal structure.

The present invention discloses a kit or system of chemical coating components, which is applicable on horizontal, vertical, tilted surfaces and overhead of an operator, for repair and/or reconstitution of worn rubber and/or metal surfaces. The invention also relates to the use of said equipment coating kit and method of coating a worn surface. In particular, the invention is also directed to a metal primer adhesive component, which is also part of the kit. Said kit or system of chemical components for coating worn surfaces has the great advantage of being prepared manually and applied in situ. The combination of components and high performance of the same allows to apply the coating with high adherence on natural or synthetic rubber and metal substrates. On the other hand, the fast application and curing of the coating (1 hour at 23° C.) reduces equipment downtime and increases productivity.

Therefore, the present invention discloses a coating kit for repair and/or reconstitution of rubber and/or metal worn areas, applicable on horizontal, vertical or tilted surfaces, which comprises:
a component A, main resin, which is a base composition comprising:
   (i) up to 90% of a polyurethane prepolymer having free isocyanate groups;
   (ii) up to 25% solvents;
   (iii) up to 35% of at least a pigment;
   (iv) up to 10% of at least an additive; and
a component B, hardener, which is a mixture comprising:
   (i) up to 90% of at least a monomeric or polymeric aromatic polyamine;
   (ii) up to 50% of at least a solvent;
   (iii) up to 35% additives;
   (iv) up to 35% pigment; and
a component C, comprising:
   (i) up to 10% of a rubber oxidative primer adhesive, which is selected between an organic oxidant and an inorganic oxidant, wherein:
      the organic oxidant is selected from hydantoins and organic peroxides; and
      the inorganic oxidant is selected from mono-, di- and trichloroisocyanuric acid, hydrogen peroxide, ammonium/sodium/potassium persulfate and chlorine dioxide; and
   (ii) up to 99.5% of at least a solvent;
a component D, metal primer adhesive, comprising a thermosetting bicomponent (DB) or a thermoplastic monocomponent (DM), where:
   The thermosetting bicomponent is made up of 2 components:
   First component (DB1) comprising:
      (i) up to 95% of at least a solvent;
      (ii) up to 5% of at least a pigment;
      (iii) up to 5% of at least an additive;
      (iv) up to 25% of a thermoplastic resin, which is selected from phenoxy resin, polyester resin, nitrocellulose resin, CAB/CAP resin, polyurethane resin, phenolic resin, resorcinol resin, methacrylic resin, vinyl resin, polyamide/polyamine resin;
      (v) up to 10% of an epoxy resin, which is selected from epoxy ester resin, epoxy ether resin, epoxy amino resin, epoxy hydrocarbon/olefin resin, epoxy heterocyclic resin; and
   Second component (DB2) comprising:
      (i) up to 90% of at least a solvent;
      (ii) up to 5% of at least an additive;
      (iii) up to 15% of functional (monomeric, polymeric) resins, where the functional resin is at least a polyamine, or at least a polysulfide;
   wherein,
   the thermoplastic monocomponent (DM) comprises
      (i) up to 95% of at least a solvent;
      (ii) up to 5% of at least a pigment;
      (iii) up to 5% of at least an additive;
      (iv) up to 15% of high molecular weight thermoplastic resins, selected from epoxy resin, phenoxy resin, polyester resin, nitrocellulose resin, CAB/CAP resin, polyurethane resin, resorcinol resin, methacrylic resin, vinyl resins, polyamide resin; and
      (v) up to 15% of at least a functional (monomeric, polymeric) resin, where the functional resin is at least a polyamine, or at least a polysulfide; and
a component E, which corresponds to an oxygenated and/or hydrocarbon cleaning solvent.

It should be understood that percentage values (%) for all the components described above and those described throughout the invention, correspond to percentages by weight with respect to the total of each composition in which they are described.

Component A, which is the main resin (also called resin/polyisocyanate/prepolymer), comprises: (i) up to 90% of a polyurethane prepolymer having free isocyanate groups; (ii) up to 25% of at least a solvent; (iii) up to 35% of at least a pigment; and (iv) up to 10% of at least an additive.

Polyurethanes are formed by reaction of a polyisocyanate with other reactive groups. Isocyanates are compounds highly reactive with different types of substances and functional groups. The main chemical groups reactive with isocyanates are: primary amines, secondary amines, primary hydroxyl, secondary hydroxyl, primary mercaptan, secondary mercaptan, carboxyl, and water. For this reason, isocyanate groups are very sensitive to atmospheric humidity due to the raw materials found in their formulation.

Polyurethane prepolymer (polyurethane resin), as its name suggests, is a small molecular size (low molecular weight around 400-4,200 g/mol) structure produced by reaction of a polyol (polyester, polyether (PPG, PEG, PTMG and mixtures), polycarbonates, polycaprolactones) with an excess of (aromatic (TDI, MDI PDI), aliphatic (HDI) and cycloaliphatic (IPDI, HDMI)) polyisocyanate, to get a final product having 2-10% of free NCO groups. Prepolymers are low and medium viscosity products, which may or may not crystallize at room temperature. Crystallized prepolymers diluted with solvents, and with appropriate solubility parameters will lower the crystallization point at lower temperatures.

Prepolymer is made with the aim of increasing viscosity of initial raw materials and their homogenization, reducing free isocyanate monomers and polymerization exotherm, reducing gelation time with subsequent reaction with other functional groups to produce a hard elastomer. Most common prepolymer is the reaction between polyisocyanate with polyols.

Prepolymer (Component A or Resin or Polyisocyanate) together with other ingredients will react together with component B, which has the function of hardening, and acts as a catalyst/chain extender, causing an increasing of size (i.e. a higher molecular weight), to produce a polyurethane, polyurea or polyurethane-urea having properties suitable for use in all types of rubber coatings, such as conveyor belts.

Component A reacts with component B at a ratio of 1:(1.01-1.05)=NCO:NH to generate a final urethane-urea elastomer in a few minutes, which may be applied at room temperature.

Component A comprises additives selected from thickeners, moisture absorbers and defoamers.

Component B is a hardener (catalyst or chain extender), a mixture comprising up to (i) 90% of at least a monomeric or polymeric aromatic polyamine; (ii) up to 35% of at least an additive; (iii) up to 35% of at least a pigment; (iv) up to 50% of at least a solvent.

The chain extender is the higher aromatic liquid component used to react with the isocyanate group, causing transition from liquid state into solid state, i.e., hardening, and, consequently, increasing molecular size. Aromatic amine chain extender provides a reaction rate with isocyanate group suitable for the product application. Chain extender mixture may be pure or diluted with a compatible diluent. It may be pigmented and may incorporate a thickener- and/or accelerant-based additive. This type of component must have a pasty consistency to facilitate incorporation into component A, mixing and product application.

Catalysis ratio of component A/component B in weight equivalents=NCO/NH=0.8−1.2.

Thus, component B is selected from monomeric polyamine and polymeric/oligomeric diamine, wherein the monomeric polyamine component is selected from the group consisting of 2,4 and 2,6 isomers of DETDA (diethyltoluenediamine), methylenebis(N,N-dibutyldianiline), 3,5-dimethylthio-2,4-toluenediamine, 3,5-dimethylthio-2,6-toluenediamine, methylene dianiline (MDA), 4,4′-methylene-bis-(2-ethyl-6-methylaniline) (MMEA), 4,4′-bis-(2,6-diethylaniline) (MDEA), 4,4′-methylene-bis-(2-isopropyl-6-methylaniline) (MMIPA), 4,4′-bis(sec-butylamino)diphenylmethane, phenylenediamine, methylene-bis-orthochloroaniline (MBOCA), 4,4′-methylene-bis-(2-methyl-aniline) (MMA), 4,4′-methylene-bis-(2-chloro-6-ethylaniline) (MCEA), 1,2-bis(2-amino-phenylthio)ethane, 4,4′-methylene-bis(2,6-diisopropylaniline) (MDIPA), Dimethylthio toluene diamine (DMTDA), 2-ethyl 1,3-diaminobenzene, 1-methyl-3,5-diethyl-2,4-diamino benzene, 1-methyl-3,5-diethyl 2,6-diaminobenzene, 1,3,5-triethyl-2,4-diaminobenzene, 4,4′-Methylenebis(2-chloroaniline), N,N′-di-sec-butyl-p-phenylenediamine, Bis(N-sec-butyl-p-aminophenyl)methane, 4′,4′-diamino diphenylmethane, 3,5-diamino-4-chloro-benzoic acid isobutyl ester; N,N′-Bis(1-methylpropyl)-1,4-phenylenediamine; 4,4′-Methylene-bis(N-sec-butylaniline), 4-chloro-3,5-diethyltoluene-2,6-diamine, 6-chloro-3,5-diethyltoluene-2,4-diamine, 4,4′bis-(secbutylamine)dichlorohexylmethane (SBADCHM), 4,4′bis-(secbutylamine)diphenylmethane (SBADFM), 4,4′-Methylenebis(2-chloroaniline) (MOCA), isobutyl-3,5-diamino-4-chlorobenzoate, tri-methyleneglycol-di-p-aminobenzoate (TMGDAB), 4,4′-methylene-bis-(3-chloro-2,6-diethylamine) (MCDEA), 4,4′-methylene-bis(2-chloroaniline), 4,4′-methylene-bis(2,3-dichloroaniline) (TCDAM), 4,4′-methylene-bis(2,5-dichloroaniline), 4,4′-methylene-bis(2-ethylaniline), 4,4′methylene-bis(2-isopropylaniline), dimer-bis-(4-aminobenzoate, 4,4′-methylene-bis(2,6-diethylaniline), 4,4′-methylene-bis(2-ethyl-6-methylaniline), 4,4′-methylene-bis(2-chloro-6-methylaniline), 4,4′-methylene-bis(2-chloro-6-ethylaniline), 4,4′-methylene-bis(3-chloro-2,6-diethylaniline), 4,4′-methylene-bis(2-trifluoromethylaniline), 4,4′-diaminodiphenyl ether, 4,4′-diamino-3,3′-dichlorodiphenyl ether, 4,4′-diaminodiphenyl sulfone, 4,4′-diamino-3,3′-dichlorodiphenyl sulfone; bis(4-aminophenoxyphenyl)sulfone; 1,2-bis(2-aminophenylthio)ethane, bis-(2-(2-aminophenothio)ethyl)terephthalate; 1,3-propanediol-bis(4-aminobenzoate), 1,4-butanediol-bis(4-aminobenzoate), diethyleneglycol-bis(4-aminobenzoate), triethyleneglycol bis(4-aminobenzoate, 4-chloro-3,5-diamino isopropylbenzoate, 4-chloro-3,5-diamino isobutylbenzoate, 3,5-diethyl-2,4-toluenediamine, 3,5-diethyl-2,6-toluenediamine, 3,5-dimethylthio-2,4-toluenediamine, 3,5-dimethylthio-2,6-toluenediamine, 2,2-bis(4-aminophenyl)propane, 2,2-bis(4-amino-3-methylphenyl)propane, 2,2-bis(4-amino-3-ethylphenyl)propane, 2,2-bis(4-amino-3-isopropylphenyl) propane, 2,2-bis(4-amino-3,5-methylphenyl)propane, 2,2-bis(4-amino-3,5-diethylphenyl)propane, 2,2bis(4-amino-3,5-diisopropylphenyl)propane, 2,2-bis(4-amino-3-ethyl-5-diethylphenyl)propane.

Meanwhile, the polymeric/oligomeric polyamine component is selected from the group consisting of poly(ethylene glycol)bis(4-aminobenzoate), poly(propylene glycol)bis(4-aminobenzoate), poly(tetramethylene glycol)bis(4-aminobenzoate) and poly(butylene glycol)bis(4-aminobenzoate).

Component B comprises additives that may be thickeners and/or accelerants. When component B comprises additives, these are selected from disperse polyurea, polyurethanes, high molecular weight polymers, barium, magnesium, calcium sulfonates, hydrophilic fumed silicas, non-surface modified fumed silicon oxide, hydrophobic fumed silica, fumed silicon oxide surface-modified with organic silanes/polysiloxanes, magnesium silicates, natural talc, aluminum, calcium, potassium and sodium bentonites, calcium-magnesium silicate/aluminate-based inorganic fibers, cotton fibers-based organic fibers, polyester, polyamide.

Component C is a rubber oxidative primer adhesive, comprising (i) up to 10% of a rubber oxidative primer adhesive, which is selected from an organic oxidant and an inorganic oxidant; and (ii) up to 99.5% of at least a solvent.

Wherein the organic oxidant is selected from hydantoins and organic peroxides; wherein the inorganic oxidant is selected from mono-, di- and trichloroisocyanuric acid, hydrogen peroxide, ammonium/sodium/potassium persulfate and chlorine dioxide.

Optionally, the rubber oxidative primer adhesive further comprises at least a pigment and at least an additive, wherein the additive optionally comprises thickener.

Priming is used as a bonding bridge for polyurethane on the rubber surface. Rubber primer may or may not be diluted with solvent to facilitate application and penetration into rubber pores and allow a more intimate reaction with its functional groups, which leads to a product that dries quickly at room temperature.

Suitable solvents for thinning rubber primers may be the same used for the cleaning solvent (component E), for a solids content of 0.1-10% by weight of oxidant in ester solvent.

Component C is a fast-drying liquid oxidant that is applied on natural or synthetic rubber substrates for binding of the mixture of components A+B.

Average adherence of the system applied for rubber priming based on 3-dibromo-5,5-dimethylhydantoin or trichloroisocyanuric acid on common rubber is 22.5 N/mm2

Component D is a primer adhesive for metal, is made up of a thermosetting bicomponent (DB1+DB2) or a thermoplastic monocomponent (DM). The thermosetting bicomponent is made up of the first component (DB1) comprising (i) up to 95% of at least a solvent; (ii) up to 5% of at least a pigment, (iii) up to 5% of at least an additive, (iv) up to 25% of a thermoplastic resin, which is selected from phenoxy resin, polyester resin, nitrocellulose resin, CAB/CAP resin, polyurethane resin, phenolic resin, resorcinol resin, methacrylic resin, vinyl resin, polyamide/polyamine resin; (v) up to 10% of an epoxy resin, which is selected from epoxy ester resin, epoxy ether resin, epoxy amino resin, epoxy hydrocarbon/olefin resin, epoxy heterocyclic resin; and a second component (DB2) comprising (i) up to 90% of at least a solvent; (ii) up to 5% of at least an additive; (iii) up to 15% of functional (monomeric, polymeric) resins, wherein the functional resin is at least a polyamine, or at least a polysulfide; with the thermoplastic monocomponent (DM) comprising (i) up to 95% of at least a solvent; (ii) up to 5% of at least a pigment; (iii) up to 5% of at least an additive; (iv) up to 15% of high molecular weight thermoplastic resins, selected from epoxy resin, phenoxy resin, polyester resin, nitrocellulose resin, CAB/CAP resin, polyurethane resin, resorcinol resin, methacrylic resin, vinyl resins, polyamide resin; and (v) up to 15% of at least a functional (monomeric, polymeric) resin, where the functional resin is at least a polyamine, or at least a polysulfide.

When the first component of the thermosetting bicomponent is an epoxy resin, it is preferably an epoxy-ether resin.

The second component of the thermosetting bicomponent is a polyamine selected from aliphatic amine, cycloaliphatic amine, and aliphatic amine with a benzene ring. The aliphatic amine being selected from 1,6-hexamethylene diamine, 1,5-diamine-2-methylpentane, methyl 2,6-diaminehexanoate, 2,2,4-trimethylhexane-1,6-diamine, 2,4,4-trimethylhexane-1,6-diamine, ethylenediamine, diethylenetriamine, linear and branched triethylenetetramine, tetraethylenepentamine, dipropylenetriamine, dimethylaminepropylamine, N,N′-bis-(2-aminoethyl)piperazine, N-[(2-aminoethyl]piperazine, N-(2-aminoethyl)-N′-[2-aminoethyl]amino)ethyl]1,2-ethanediamine, 4-(2-aminoethyl)-N-(2-aminoethyl)-N′-(2-[2-(2-aminoethyl)amino]ethyl]-1,2-ethanediamine, 1-(2-aminoethyl)-4-[(2-aminoethyl)amino]ethyl]-piperazine), 1-[2-[2-[(2-aminoethyl)amino]ethyl]-piperazine), diethylenediamine, triethylenediamine, tetraethylenediamine, of polyethyleneimines having molecular weight 400-3,000,000 g/mol reacted with monoepoxies or fatty acids, propylenediamine, dipropylenediamine, tripropylenediamine, tetrapropylenediamine, polypropylenediamine, polyethylene/propylene diamine, polyethylene monoamine, polyethylene glycol triamine, polypropylene glycol triamine, dimer amine.

Wherein the eycloaliphatic amine is selected from 2,5(6)-bis(aminomethyl)bicyclo[2.2.1]heptane; 1,3,3-trimethyl-1-(aminomethyl)-5-aminocyclohexane; 1,8-diamine-2,4-dimethyloctane; octahydro-4,7-methane-1H-indendimethyldiamine; 1,1′-methylenebis(4-aminocyclohexane), bis(aminomethyl)cyclohexane; 1,3-bis(aminomethyl)cyclohexane; bis(aminomethyl)norbornane; n-aminoethylpiperazine.

The aliphatic amine with a benzene ring is selected from 1,4-xylylene diamine (p-xylene diamine); 1,3-xylylene diamine (m-xylene diamine).

The second component of the thermosetting bicomponent being a polysulfide, preferably a mercaptan, with mercaptan being selected from the group consisting of trimethylolpropane tri(3-mercaptopropionate); tris[2-(3-mercaptopropionyloxy)ethyl]isocyanurate; glycol ii(3-mercaptopropionate); di-pentaerythritol hexa(3-mercaptopropionate); pentaerythritol tetra(3-mercaptopropionate); ethoxylated trimethylolpropane (3-mercaptopropionate); polycaprolactone tetra(3-mercaptopropionate); 4-(mercaptomethyl)-3,6-dithia-1,8-octanedithiol; 1,2-bis(2-mercaptoethoxy)ethane; 1,2-bis(mercaptomethyl)-1,3-propanediol; 3-mercapto-2,2-bis(mercaptomethyl)-1-propanol, 2,2-bis(mercaptomethyl)-1,3-propanethiol; 2-ethyl-2-(mercaptomethyl)-1,3-propanethiol.

Wherein, the second component of the thermosetting bicomponent optionally comprises at least a solvent. On the other hand, the second component of the thermosetting bicomponent optionally comprises at least a pigment; and said second component of the thermosetting bicomponent optionally comprises at least an additive, where said additive may be thickeners and/or accelerants.

Where the thermoplastic monocomponent further comprises at least a solvent, at least a pigment and at least an additive. The additive optionally being thickener and/or accelerants.

Component D is a liquid adhesive, which may be monocomponent (DM) or bicomponent (DB), both fast-drying components, wherein the bicomponent is made up from the mixture of components DB1+DB2, i.e., from the mixture of a first component (DB1) and a second component (DB2), which is applied on metal substrates at room temperature for binding the mixture of component A plus component B.

Priming is used as a bonding bridge between a metal substrate and resin, fast drying at room temperature. Monocomponent priming is easier for users because no other component is required before its use, being simpler for the user because simplifies its application without major problems relating to pot-life.

In this two-component system, unlike the one-component system, component B should be added to A and applied before it gels (shelf life). The great advantage of the bicomponent primer over the monocomponent primer is its higher thermal resistance (final crosslinked product having strong covalent bonds plus weak secondary bonds between molecules), i.e., the bicomponent primer work at higher temperatures. The one-component system, being a thermoplastic system, suffers more with temperature because only weak secondary bonds interact between molecules.

Formulation flowchart of the metal monocomponent primer (DM, (bicomponent primer for metal)) (Diagram 1)

Metal monocomponent thermoplastic primer (DM)(1 component), is a fast drying primer having high molecular weight and glass-transition (TG). Monocomponent system only produces physical drying by solvent evaporation, leaving only the solid resin with or without functional groups.

Thermoplastic Resins/Functional Resins mixture ranges from 1/100 to 100/1. For the present invention the preferred thermoplastic resin/functional resin mixture ratio is 4/1 to 1/4 by.

Solid content may be from 0.1 to 50% in organic solvents. For the present invention the preferred solid content ranges from 5 to 35%.

Resin application on the one component primer will make it react with the functional groups in the form of a covalent bond (high energy) and weak secondary molecular forces, or interact only by weak secondary molecular forces (hydrogen bonds, Van der Waals, etc.) without chemical reaction.

The selected solvent must have stability and compatibility with the resin, and have a high volatility to accelerate the application. Said solvent should not contain free reactive OH, SH or NH groups, since these will interfere with resin adhesion.

Primer product paint eases the application on previously scraped metal surfaces, coloration is very important since the user will know in advance where this primer was applied or not.

The choice of a pigment/dye should be made on request. This material must have stability and compatibility with the resin/solvent system and not act as a retardant or adhesion blocker for the resin.

Thickening additives may be used for vertical surfaces, to produce non-Newtonian (thixotropic or pseudoplastic) behavior to reduce runoff and standardize application. Accelerant additives will act as reaction amplifiers, increasing the functional group and resin reaction rate.

### Thermoplastic Resin:

The most common high molecular weight thermoplastic polymers/resins are: polyester, acrylic, vinyl, polyamides, epoxies, polyamines, phenolics, CAB, nitrocellulose, polyurethanes, phenoxy. These resins may contain amine and sulfide groups. These resins are diluted with the same solvents used for cleaning solvent (see solvents) up to a solid content of 0.1-50% by weight. Preferably 2-30% solid content. These products have a molecular weight of 5,000-200,000 g/mol.

High molecular weight epoxy resins: Bisphenol A epoxy resins of this chemical class have a molecular weight from 600-20,000 g/mol and a glass-transition temperature of 30-150° C. and very few free epoxy groups (0.5-3.0% oxirane groups).

Phenoxy resin: High molecular weight bisphenol A epichlorohydrin resins without free epoxy groups. This type of resin has a large number of secondary hydroxyl groups, as well as carboxylic, amino, sulfuric and phosphoric groups. These resins have a molecular weight of 10,000-90,000 g/mol and a glass-transition temperature of 60-150° C.

Polyester resins: Polyester resins made up of polycarboxylic acids (see Diagram 1) with polyols (see above) have various molecular weights ranging from 10,000-200,000 g/mol and a glass-transition temperature of 60-150° C. This type of resin may or may not have free functional groups such as carboxyl, hydroxyl, amine, sulfide, sulfonic or phosphoric.

Nitrocellulose Resins: This type of resin is produced from a cellulose nitration reaction, which can give a high nitration rate (11.8-12.3% nitrogen soluble in various solvent types) and low nitration rate (10.8-11.3% nitrogen soluble in alcohols). They have a molecular weight from 15,000-250,000 g/mol and a glass-transition temperature higher than 170° C. Glass-transition cannot be established because nitrocellulose is very unstable susceptible to thermal breakdown.

CAB/CAP resins: This class of resin is produced from the reaction of cellulose with acetic acid, butyric acid or propionic acid. This resin can vary in molecular weight from 10,000-100,000 g/mol and have a glass-transition temperature of 70-200° C. The amount of free hydroxyl groups differs depending on the type of product.

Polyurethane resins: Polyurethane resins made up from polyisocyanates (see Chart 1 and polyols (see above) with or without carboxylic, hydroxyl, amino, thiol, sulfonic or phosphoric groups. Having different molecular weights from 10,000-200000 g/mol and a transition-glass temperature from 60-150° C.

Phenolic Resins: Phenolic resins based on phenol, cresols, xylenes, alkyl phenols, salicylic acid, resorcinols, alkyl resorcinols, bisphenol A and F, lignin, tannin, cardanol, reacted with formalin, paraformaldehyde, acetaldehyde, isobutyraldehyde, butyraldehyde, benzaldehyde, 2-ethyl hexaldehyde, furfuraldehyde. With an excess of aldehydes that produce a Resol (molecule with methyl groups) or with an excess of phenols that produce Novolac. Molecular weight from 400-60,000 g/mol and glass-transition temperature of 30-150° C.

(Meth)acrylic resins: Radical reaction of peroxides or azo compounds of alkyl (C1-C20) acrylic or methacrylic monomers with carboxylated, hydroxylated, amino, thiol, sulfonic or phosphoric monomers having a molecular weight from 2,000-100,000 g/mol and a glass-transition temperature of 40-170° C.

Vinyl resins: Radical reaction of peroxides or azo compounds of vinyl monomers (ethylene, propylene, vinyl chloride), vinyl esters (vinyl acetate, vinyl neodecanoate, vinyl neononanoate), alkyl (C1-C20) vinyl ethers with carboxylated, hydroxylated, amine, thiol, sulfonic or phosphoric monomers. Molecular weight from 2,000-100,000 g/mol and a glass-transition temperature of 40-170° C.

Polyamide resins: Resins produced from reactions of carboxylic acids/oligomers with polyamines. This type of resin is characterized by an excess of amide groups in its molecular structure. Molecular weight from 400-60,000 g/mol and glass-transition temperature of 50-180° C.

Polyamine resins: Resins produced from the reaction of amines with epoxy or unsaturated reactants having free double bonds. This type of resin is characterized by an excess of amine groups in its molecular structure. Molecular weight from 400-60,000 g/mol and glass-transition temperature of 50-180° C.

### Functional Resin:

Functional polymers/resins may be: Epoxy-amines (with an excess of amine groups) and Epoxy-sulfide (excess of sulfide groups). These resins are diluted with the same solvents used for the cleaning solvent (see solvents) up to a solid content of 0.1-50% by weight. Preferably 2-15% solid content. These products have a molecular weight of 400-200,000 g/mol and a glass-transition temperature of 50-150° C.

Epoxy-amine resins: Resins produced from reaction between epoxy resins and polyamines. This type of resin is characterized by an excess of amino groups in its molecular structure. Molecular weight from 400-60,000 g/mol and glass-transition temperature of 50-150° C.

Epoxy-sulfide resins: Resins produced from reaction between epoxy resins and polysulfide/thiols/mercaptan. This type of resin is characterized by an excess of sulfur groups in its molecular structure. Molecular weight from 400-60000 g/mol and glass-transition temperature of 50-150° C.

Formulation flowchart of the metal bicomponent primer (DB, (bicomponent primer for metal)) (see Diagram 2)

Metal bicomponent primer (Component DB) (2 components), fast-drying component having high molecular weight and glass-transition (TG). This two-component system first undergoes physical drying by solvent evaporation, leaving the solid resin. This solid resin will react with the reagent contained in component A and the reagent contained in component B via their reactive functional groups.

Mixture of functional/non-functional thermoplastic resins with/without functional epoxy/amino/sulfide resins ranges from 1/100 to 100/1. For the present invention the preferred mixture ratio of thermoplastic resin to epoxy/functional resin is from 8/1 to 1/8 by weight.

Epoxy/(amine/sulfide) reaction equivalents range from 0.1/1.0 and 1.0/0.1, according to the system type. Best epoxy/(amine/sulfide) ratio is from 0.8/1.0 to 1.0/0.8. Thermoplastic resin/functional resin ratio is from 0/100 to 90/0, with the best thermoplastic/functional resin ratio being from 20/80 to 80/20

Solid content may be from 0.1 to 50% in organic solvents. For the present invention the preferred solid content ranges from 5 to 35%.

Resin application on the bicomponent primer (previously mixed with component A+B) will react with the functional groups to form a covalent bond (high energy). Said reaction will be more or less fast depending on the type of functional groups and accelerant.

The selected solvent (or diluent) should have compatibility and stability with the resins and high volatility to speed up the application. Said solvent should not contain free reactive OH, SH or NH groups, since these will interfere with resin adhesion.

Primer product paint eases the application on previously scraped metal surfaces, coloration is very important since the user will know in advance where this primer was applied or not.

The choice of a pigment/dye should be made on request. This material must have stability and compatibility with the resin/solvent system and not act as a retardant or adhesion blocker for the resin.

Thickening additives may be used for vertical surfaces, to produce non-Newtonian (thixotropic or pseudoplastic) behavior and reduce runoff and standardize application.

Accelerant additives will act as reaction amplifiers, increasing the functional group and resin reaction rate.

Fast-drying metal bicomponent thermosetting primer (Component DB) (2-component) may be mixed with a one-part primer at a ratio of 0-90%. The metal bicomponent epoxy primer system may react with the architectures shown in the following table 1:

TABLE 1

| | | | Chemical group from |
|---|---|---|---|
| System | | | the mixture of |
| Type | Component 1 | Component 2 | component 1 + 2 |
| 13 | Epoxy-ester | Aliphatic/aliphatic | Ester-amino |
| | | with benzene | |
| | | ring/cycloaliphatic | |
| | | amine | |
| 14 | | Polyamide | Ester-amide |
| 15 | | Amino-amide | Ester-amino-amido |
| 16 | | Phenalkamine | Ester-amino-phenol |
| 17 | | Mercaptans | Ester-thioether |
| 18 | Epoxy-ether | Aliphatic/aliphatic | Ether-amino |
| | | with benzene | |
| | | ring/cycloaliphatic | |
| | | amine | |
| 19 | | Polyamide | Ether-amide |
| 20 | | Amino-amide | Ether-amino-amido |
| 21 | | Phenalkamine | Ether-amino-phenol |
| 22 | | Mercaptans | Ether-thioether |
| 23 | Epoxy-amine | Aliphatic/aliphatic | amino-amino |
| | | with benzene | |
| | | ring/cycloaliphatic | |
| | | amine | |
| 24 | | Polyamide | amino-amino |
| 25 | | Amino-amide | Amino-amide |
| 26 | | Phenalkamine | Amino-amino-phenol |
| 27 | | Mercaptans | Amino-thioether |
| 28 | Epoxy-olefin | Aliphatic/aliphatic | Amino |
| | | with benzene | |
| | | ring/cycloaliphatic | |
| | | amine | |
| 29 | | Polyamide | Amide |
| 30 | | Amino-amide | Amino-amide |
| 31 | | Phenalkamine | Amino-phenol |
| 32 | | Mercaptans | Thioether |
| 33 | Epoxy- | Aliphatic/aliphatic | Heterocyclic-amine |
| | heterocyclic | with benzene | |
| | | ring/cycloaliphatic | |
| | | amine | |
| 34 | | Polyamide | Heterocyclic-amide |
| 35 | | Amino-amide | Heterocyclic-amino- |
| | | | amide |
| 36 | | Phenalkamine | Heterocyclic-amino- |
| | | | phenol |
| 37 | | Mercaptans | Heterocyclic-thioether |

The types of systems preferably used are 18, 19, 20, 21 and 22.

### Epoxy Resins Used for Metal Primer

Epoxy monomers and polymers may have a molecular weight range from 90 to 200,000 g/mol having various functionalities of 1, 2, 3, 4, 6 and higher. The functional group is oxirane group, more commonly known as epoxy, which can react with different types of common reactive groups at room temperature, such as primary and secondary amines, primary and secondary thiols (mercaptans or sulfides).

Epoxy-ester resin, reaction of epichlorohydrin with carboxylic compounds:
Reaction of epichlorohydrin with glycidyl methacrylate homopolymers or copolymers with other alkyl (C1-C18) monomers. Glycidyl esters of aliphatic, aromatic or alicyclic polybasic acid such as maleic acid, fumaric acid, itaconic acid, succinic acid, glutaric acid, suberic acid, adipic acid, azelaic acid, sebacic acid, dimer acid, trimer acid, phthalic acid, isophthalic acid, terephthalic acid, trimellitic acid, trimesic acid, pyromellitic acid, tetrahydrophthalic acid, hexahydrophthalic acid, and endomethylene tetrahydrophthalic

### Epoxy-Ether Resins:

Reaction of epichlorohydrin with phenolic compounds such as hydroquinone, resorcin, pyrocatechol, phloroglucinol, dihydroxy naphthalene, bisphenol, methylenebisphenol (bisphenol F), methylene bis(orthocresol), ethylidene bisphenol, isopropylidene bisphenol (bisphenol A), tetraphenol (orthocresol), isopropylidene(hydroxycumylbenzene), 1,4-bis(4-hydroxycumylbenzene), 1,1,3-tris(4-hydroxyphenyl)butane, 1,1,2,2-tetra(4-hydroxyphenyl)ethane, thiobisphenol, sulfobisphenol, oxybisphenol, phenol novolac, orthocresol novolac, ethylphenol novolac, butylphenol novolac, octylphenol novolac, resorcin novolac, bisphenol A novolac, bisphenol F novolac and terpenediphenol
Polyhydroxy ethylene oxide compounds and/or propylene oxide adducts of polynuclear polyhydroxy or mononuclear phenolic compounds described above; polyglycidyl ether compounds of hydrogenation products of the mononuclear polyhydric phenolic compounds described above; polyglycidyl ethers of polyols such as ethylene glycol, propylene glycol, butylene glycol, hexanediol, polyglycol, thiodiglycol, glycerine, trimethylol propane, pentaerythritol, sorbitol and bisphenol A-ethylene oxide adducts.

### Epoxy-Amine Resin:

N,N-diglycidyl aniline and bis(4-(N-methyl-N-glycidylamino)phenyl)methane.

### Hydrocarbon/Olefin Epoxy Resin:

Vinylcyclohexene diepoxide, dicyclopentanediene diepoxide, 3,4-epoxycyclohexylmethyl-3,4-epoxycyclohexanecarboxylate, 3,4-epoxy-6-methylcyclohexylmethyl-6-methyl-epoxy(methylcyclohexylmethyl)adipate; epoxidized polybutadiene and styrene-butadiene copolymers epoxidized with peracetic acid.

### Heterocyclic Epoxy Resins:

Triglycidyl isocyanurate.

### Amines Used for Metal Primer

Aliphatic with Benzene Ring:
1,4-xylylene diamine (p-xylene diamine), 1,3-xylylene diamine (m-xylene diamine).

Amine adducts produced from the reaction between epoxy resins with polyamines. This type of resin is characterized by an excess of amino groups in its molecular structure. Molecular weight from 400-60,000 g/mol.

### Aliphatic:

1,6-hexamethylene diamine), 1,5-diamine-2-methylpentane, Methyl 2,6-diaminehexanoate, 2,2,4-Trimethylhexane 1,6-diamine, 2,4,4-Trimethylhexane 1,6-diamine, Ethylenediamine, diethylenetriamine, linear and branched triethylenetetramine, tetraethylenepentamine, dipropylenetriamine, dimethylaminepropylamine, N,N′-bis-(2-aminoethyl)piperazine, N-[(2-aminoethyl]piperazine, N-(2-aminoethyl)-N′-[2-aminoethyl]amino)ethyl]1,2-ethanediamine, 4-(2-aminoethyl)-N-(2-aminoethyl)-N′-(2-[2-(2-aminoethyl)amino]ethyl]-1,2-ethanediamine, 1-(2-aminoethyl)-4-[(2-aminoethyl)amino]ethyl]-piperazine), 1-[2-[2-[(2-aminoethyl)amino]ethyl]-piperazine), diethylenediamine, triethylenediamine, tetraethylenediamine, adducts of polyethyleneimines having molecular weight 400-3,000,000 g/mol reacted with monoepoxies or fatty acids, propylenediamine, dipropylenediamine, tripropylenediamine, tetrapropylenediamine, polypropylenediamine having molecular weight of 400-6,000 g/mol, polyethylene/propylenediamine having molecular weight of 400-6,000 g/mol, polyethylenemonoamine having molecular weight of 200-6,000 g/mol, polyethylene glycoltriamine having molecular weight of 200-6,000 g/mol, polypropylene glycoltriamine having molecular weight of 200-6,000 g/mol.
Dimer amine. Amino groups should be activated with amine bases, phenols, or Manich bases for fast reaction with epoxy groups.

### Cycloaliphatic:

2,5(6)-bis(aminomethyl)bicyclo[2.2.1]heptane, 1,3,3-trimethyl-1-(aminomethyl)-5-aminocyclohexane, 1,8-diamine-2,4-dimethyloctane, octahydro-4,7-methano-1H-indenedimethyldiamine, 1,1′-methylenebis(4-aminocyclohexane), bis(aminomethyl)cyclohexane, 1,3-bis(aminomethyl)cyclohexane, bis(aminomethyl)norbornane, n-aminoethylpiperazine.
Amino groups should be activated with amine bases, phenols, or Manich bases, for fast reaction with epoxy groups.

### Polyamide:

Dimeric/trimeric acid with ethylenediamine, diethylenetriamine, triethylenetetramine.
Polyamines made from carboxylic acids with various aliphatic, aliphatic with benzene ring, cycloaliphatic amines.
Amido groups should be activated with amine bases, phenols or Manich bases, for rapid reaction with epoxy groups.

### Amino-Amides:

Reaction of amines with monocarboxylic acid, to improve compatibility with epoxies, reduce amine volatility, increase hydrophobicity and consequent high hygroscopicity.

### Phenalkamines:

Phenols react with amines and formaldehyde. This type of product has the advantage of having the phenolic group in its molecule working as an accelerant so that the amine group reacts more easily with epoxies.

### Sulfides (Thiols, Mercaptan) Used for Metal Primer

### Mercaptan/Thio/Sulfide:

Polysulfides or hydropolysulfides (monoethylene glycol and/or diethylene glycol) having molecular weight of 500-10,000 g/mol with functionality 2 or 3. Trimethylolpropane Tri(3-mercaptopropionate), Tris[2-(3-mercaptopropionyloxy)ethyl]isocyanurate, Glycol di(3-mercaptopropionate), di-pentaerythritol hexa(3-mercaptopropionate), pentaerythritol tetra(3-mercaptopropionate), ethoxylated trimethylolpropane (3-mercaptopropionate) having molecular weight of 500-3000 g/mol, polycaprolactone tetra (3-mercaptopropionate), 4-(mercaptomethyl)-3,6-dithia-1,8-octanedithiol, 1,2-bis(2-mercaptoethoxy)ethane, 1,2-bis(mercaptomethyl)-1,3-propanediol, 3-mercapto-2,2-bis(mercaptomethyl-1-propanol, 2,2-bis(mercaptomethyl-1,3-propanethiol, 2-ethyl-2-(mercaptomethyl)-1,3-propanethiol. Mercaptan or thiol groups should be activated with amine bases or strong bases for fast reaction with epoxy groups.

Component E is an oxygenated and/or hydrocarbon cleaning solvent, which may have different formulations to be used before applying the catalyzed polyurethane. Cleaning solvent only contains pure organic solvents or mixtures thereof. Said solvent must have the following properties:
High purity, should not contain contaminants such as oils, greases and moisture. This product will remove/reduce surface contamination.
Easy application and cleaning of rubber and metal surface previously scraped and removed excess dust.
Fast evaporation.
Having high polarity to swell the rubber in order to cause surface pore opening for better adhesion of the resin.
   Wherein the oxygenated cleaning solvent (component E) is selected between:
      esters, such as methyl acetate, ethyl acetate, n-propyl acetate, isopropyl acetate, n-butyl acetate, sec-butyl acetate, isobutyl acetate, tert-butyl acetate, n-pentyl acetate, isopentyl or isoamyl acetate;
      ketones, such as acetone, methyl ethyl ketone, methyl isobutyl ketone, methyl isoamyl ketone, methyl n-propyl ketone; and
      ethers, such as tetrahydrofuran.

Wherein the hydrocarbon cleaning solvent (component E) is selected from toluene, xylol, diethyl benzene, triethyl benzene, cyclohexane and n-hexane.

The different components of the kit or chemical system may include accelerants, which are used as chain extenders to accelerate the reaction of the isocyanate group, these may be present in an amount of 0.01 to 5%. There are different types of accelerants for each type of application, some slower and others faster in terms of acceleration, adhesion or stability within the product over time. Some types of accelerants are:
Metal salts of carboxylic acids (octanoic, 2-ethyl hexoic, acetyl acetonoic, naphthanoic, oleic, stearic, acetic).
Alkyl carboxylic, phosphoric and sulfonic acid.
Zinc salt, zirconium, cobalt, bismuth, tin, vanadium, copper, titanium, mercury.
Tertiary amines 1,4-diazabicyclo[2.2.2]octane (DABCO), 1,8-diazabicyclo[5.4.0]undec-7-ene (DBU).
Tetra alkyl/aryl titanates
Ethyl, isopropyl, butyl phenyl, cresyl, octyl.
Acid and neutral stannates
dibutyl-tin dilaurate, tetrabutyl-tin dilaurate.

Solvents or diluents are chemical compounds that will act as solvents to keep the ingredients (resins and/or pigments and/or additives) in a liquid/viscous state in the container with suitable stability for a long period of time, also easing application.

The main properties of diluents are:
Reducing resin viscosity to keep it in a liquid state and easy to apply.
It should be volatile to evaporate during and after application, not being part of the final product.
The choice of a solvent/solvents is based on: higher solvency or solubility with the resin, viscosity, boiling point, evaporation rate, toxicity, odor, cost, etc.
Solvent does not affect the final mechanical properties of the applied resins and primers.
Diluent may be added from 0.01 to 99%.

Solvent may be found single or in a mixture of various types. The solvent should be inert to the polyurethane prepolymer and should not have reactive groups such as OH—, NH—, SH—, COOH or moisture reactive groups.

Solvent is selected from oxygenated solvents, hydrocarbon solvents and mixtures thereof.

In particular, solvent is selected from:
esters, such as methyl acetate, ethyl acetate, n-propyl acetate, isopropyl acetate, n-butyl acetate, sec-butyl acetate, isobutyl acetate, tert-butyl acetate, n-pentyl acetate, isopentyl or isoamyl acetate, n-hexyl acetate, 2-ethyl hexyl acetate, cyclohexyl acetate, methoxypropyl acetate, butyl glycol acetate, ethyl glycol acetate, ethoxypropyl acetate, butoxypropyl acetate, dimethyl ester, phenyl glycol acetate, and phenoxypropyl acetate;
ketones, such as, acetone, methyl ethyl ketone, methyl n-amyl ketone, methyl isobutyl ketone, methyl isoamyl ketone, isophorone, cyclohexanone, acetophenone and methyl n-propyl ketone;
carbonates, such as, dimethyl carbonate, diethyl carbonate, di-n-propyl carbonate, diisopropyl carbonate, di-n-butyl carbonate, di-sec-butyl carbonate, di-tert-butyl carbonate, di-isobutyl carbonate, di-n-pentyl carbonate, di-2-ethyl-hexyl carbonate, diphenyl carbonate and dibenzyl carbonate;
ethers, such as, tetrahydrofuran, dimethyl ether, diethyl ether and dipropyl ether;
amides, such as n-methyl pyrrolidone, n-ethyl pyrrolidone, n-propyl pyrrolidone, n-butyl pyrrolidone, n-hexyl pyrrolidone, dimethyl formamide and dimethyl acetamide;
aromatics, such as, toluene, xylol, diethyl benzene and triethyl benzene.

Pigments or dyes, when applicable, may be found in a range of 0.01-40% (pure liquid/powder or pre-dispersion/concentrate). The following table 2 shows the classification by color index CI of pigments and dyes that may be used in the kit or chemical system of the invention. Dyes (soluble) may be dissolved in solvents or resins by simply mixture. Pigments (insoluble) are dispersed in high-speed dispersers or in special mills with the help of polymers/resins plus dispersant additives compatible with the polyurethane system. Concentration of dispersed pigment concentrates may range from 5 to 60% by weight with respect to the resin plus dispersants.

TABLE 2
Numbering of Dyes and Pigments according to CI

| Chemical structure | CI number | Pigment category |
|---|---|---|
| Nitrous | 10,000-10299 | |
| Nitro | 10300-10999 | |
| Monoazo | 11000-19999 | Azo dyes |
| Disazo | 20000-39999 | Azo dyes |
| Stilbene (Diaryl Ethene) | 40000-40799 | |
| Diarylmethane | 41000-41999 | Diarylmethane dyes |
| Triarylmethane | 42000-44999 | Triarylmethane dyes |
| Xanthene | 45000-45999 | |
| Acridine | 46000-46999 | Acridine dyes |
| Quinoline | 47000-47999 | Quinoline dyes |
| Methine | 48000-48999 | |
| Thiazole | 49000-49399 | Thiazole Dyes |
| Indamine | 49400-49699 | |
| Indophenol | 49700-49999 | Indophenol dyes |
| Azine | 50000-50999 | Azine dyes |
| Oxazine | 51000-51999 | Oxazine Dyes |
| Thiazine | 52000-52999 | Thiazine dyes |
| Aminoketone | 56000-56999 | |
| Anthraquinone | 58000-72999 | Anthraquinone dyes |
| Indigoids | 73000-73999 | Indigo and Quinacridone Dyes |
| Phthalocyanine | 74000-74999 | Phthalocyanine dyes |
| Natural Dyes | 75000-76999 | |
| Inorganic Pigments | 77000-77999 | Inorganic Pigments |

Type of pigment or dye can affect hardness of Component A to catalyze with Component B, since the grinding resin of the dispersed pigment will react causing less isocyanate groups in component A. The preferred pigment herein is carbon black dispersed in polyethylene glycol-based dye or iron/cobalt spinel.

Pigment or dye can also interfere with the drying of the metal primer, since it can be acid or base depending on its chemical nature.

The amount of pigment for Component A may range from 0.1 to 40% by weight. For the present invention, the preferred range is from 2-7% by weight.

Dye used for metal primer can be used from 0.01 to 10% by weight. For the present invention, the preferred range is from 0.2-1.0% by weight.

In the case of accelerating additives, amino, amide, and sulfide groups should be accelerated with the incorporation of aliphatic/aliphatic amine bases with a tertiary benzene ring of high basicity, such as 1,4-diazabicyclo[2.2.2]octane (DABCO), 1,8-diazabicyclo[5.4.0]undec-7-ene (DBU), phenolics, phenalikamine or Mannich methylamine bases such as 2,4,6-tris(dimethylaminomethyl)phenol or 2,4-bis(dimethylaminomethyl)phenol for fast reaction with epoxy groups.

The result of the adhesion of the metal monocomponent primer (DM) and the bicomponent primer (DB) on common steel scraped with an abrasive disk followed by the application of resin, can be seen in the following table 3:

TABLE 3
Metal monocomponent primer (Example 6)
after 20 minutes of drying

| | Primer and resin + catalyst | | |
|---|---|---|---|
| | mixture application temperature | | |
| | 0° C. | 25° C. | 45° C. |
| Adhesion (N/mm) | 20-26 | 19-23 | 18-22 |

Metal monocomponent primer (Example 1)
after 20 minutes of drying

| | Primer and resin + catalyst | | |
|---|---|---|---|
| | mixture application temperature | | |
| | 0° C. | 25° C. | 45° C. |
| Adhesion (N/mm) | 40-44 | 23-31 | 20-25 |

For the present invention, in general, additives are added on the polyurethane system in small amounts ranging from 0.01 to 10% by weight. There are several types of additives that, when incorporated into the polyurethane system, help to solve problems of stability, reduction of internal and superficial imperfections, applicability and other properties. The most common additives are the following: Defoamer

Defoamer may be added from 0.01 to 5% by weight. For the present invention, the preferred amount is from 0.2 to 2.0% by weight.

Incorporation of anti-foaming additives, in addition to improving the surface appearance of the applied product, will also reduce the number of void areas within the applied film, increasing the durability of the applied coating.

Defoamers are:
Aliphatic hydrocarbons;
Hexane, Heptane, Decane, Isooctane;
Silicones;
Polydimethylsiloxane having a molecular weight of 5,000-100,000 g/mol;
Liquid fluorocarbons having a molecular weight of 150-2,000 g/mol, hexafluorobenzene, octafluorotoluene, octafluoronaphthalene and others;
Liquid fluorinated polymers having a molecular weight of 5,000-50,000 g/mol;
Fluorinated alkyl(meth)acrylates and fluorinated aryl(meth)acrylates.

### Moisture Absorbers

Incorporation of moisture absorbers in the final polyurethane will increase its useful life. Durability will increase because the water contained in a raw material will react with isocyanate group. Too much water will result in a premature gelation of the polyurethane. Therefore, the packaging containing the polyurethane should also have excellent airtightness. The amount used can range from 0.1-5.0% by weight. The suitable value for our product ranges from 0.7-1.5% by weight. Moisture absorbers are classified as:
absorption/adsorption of moisture to form hydration water
   dry salts (anhydrous)
      calcium chlorate, calcium sulfate
   molecular sieve
      zeolite powder with pores of 3 and 4 Angstroms
highly reactive mono-functional reagents forming a mono-urea in contact with water
   4-methylbenzene sulfonyl isocyanate, o-ethoxy carbonyl benzene sulfonyl isocyanate, 2,4-dichlorobenzene-1-sulfonyl isocyanate.

### Thickening Additives

Incorporation of thickening additives is essential to adjust the application properties on walls or vertical surfaces. The non-Newtonian rheological profile for this application is pseudoplastic or thixotropic. In other words, the product reduces viscosity when a force is applied (for example, during application) and viscosity increases gradually over time (thixotropic), or viscosity increases instantly (pseudoplastic) to the initial value when the applied force is removed. (after product application).

Thixotropic test may be performed with a viscometer or a rotary or oscillatory rheometer.

Rotational viscometer measures a TI (thixotropic index) value that is the ratio between the viscosity of a sample at a low (ηA) and at a high (ηB) rotational speeds at constant temperature and spindle (TI=ηA/ηB). Before each measurement, the product should be sheared at constant time, speed, agitator and quantity, so this measure could produce a reliable value.

Newtonian products have the TI value (thixotropic index)=1. For non-Newtonian products TI>1. The higher the TI value, the higher the final application layer. For the present invention, the preferred resin TI value=2-3.

Thickener may be added in an amount of 0.1-30% by weight. For the present invention, the preferred amount is 2-7% by weight.

Thickeners are classified into:
Organic
   Electrostatic interaction with other components
      Dispersed polyureas
   Associative
      Polyurethanes (HEUR)
   No electrostatic interaction with other components
      Physical (high molecular weight)
         High molecular weight polymers
         Polyethylene or polypropylene ceramic dispersion
      Salt gels
      Calcium, Magnesium, Barium Sulfonates
   Electrostatic interaction with other components
      Hydrophilic fumed silicas;
         Non-surface modified fumed silicon oxide
      Hydrophobic fumed silicas
         Fumed silicon oxide surface-modified with organic silanes/polysiloxanes
      Magnesium silicates
         Natural talc
      Bentonites
         Sodium, potassium, calcium and aluminum bentonites
   No electrostatic interaction (crosslinking) with other components
      Inorganic fibers
         Calcium-magnesium silicate/aluminate
      Organic fibers
         Cotton fibers, polyester, polyamide.

The coating kit of the present invention has the particularity that each one of components A, B, C, D and E are in independent containers and interact with each other when removed from their containers to be applied and interact with each other.

The present invention also claims a method of coating a worn metal surface, wherein the method comprises the steps of:
scraping the worn surface with an abrasive disk until the surface is clean and porous;
applying an oxygenated or hydrocarbon solvent (component E), for removing all traces of oil, grease, dust or other foreign substances resulting from shot-blasting, and allow to dry;
preparing the bicomponent thermosetting primer adhesive (component D), which is made up of a first and second component, each one in a separate container, emptying the container of the second component and transferring its content into the container of the first component, to obtain a mixture inside the container of the first component, then closing the container containing the mixture with a lid, shaking the obtained mixture for 30 seconds; or opening the container of the monocomponent thermoplastic primer adhesive;
applying the primer adhesive from the previous step as a uniform layer onto the metal surface to be treated, and let it dry;
pouring the mixture of at least an aromatic diamine and additives (component B) into the container of the base composition comprising a polyurethane prepolymer having free isocyanate groups, solvents, pigment, and an additive (component A), stirring for one minute until a homogeneous mixture is obtained;
spreading said homogeneous mixture from the previous step on the worn metal surface, using a spatula to spread and smooth the homogeneous mixture on the surface; and
waiting for a time from 45 to 60 minutes at a temperature about 23° C., until the product on the worn surfaces has set and hardened.

In another embodiment, the present invention also claims a method for coating a worn metal and rubber surface, wherein the method comprises the steps of:
scraping the worn metal surface with an abrasive disk until the surface is clean and porous;
scraping the worn rubber surface with an electric grinder with a wire brush until it is clean and porous;
applying an oxygenated or hydrocarbon solvent (component E) on the scrapped metal surface and on the rubber surface, for removing all traces of oil, grease, foreign material, dust or other substances resulting from the shot-blasting, and allow to dry;
preparing the bicomponent thermosetting primer adhesive (component D), which is made up of a first and second component, each one in a separate container, emptying the container of the second component and transferring its content into the container of the first component, to obtain a mixture inside the container of the first component, then closing the container containing the mixture with a lid, shaking the obtained mixture for 30 seconds; or opening the container of the monocomponent thermoplastic primer adhesive;
applying the primer adhesive from the previous step as a uniform layer onto the metal surface to be treated, and let it dry;
applying the mixture of rubber oxidative primer adhesive and solvent (component C) on the rubber surface to be treated, and allow to dry;
pouring the mixture of at least an aromatic diamine and additives (component B) into the container of the base composition comprising a polyurethane prepolymer having free isocyanate groups, solvents, pigment, and an additive (component A), stirring for one minute until a homogeneous mixture is obtained;
spreading said homogeneous mixture from the previous step on the worn metal surface, using a spatula to spread and smooth the homogeneous mixture on the surface; and
waiting for a time from 20 to 60 minutes at a temperature about 23° C., until the product on the worn surfaces has set and hardened.

The present invention also encompass the use of the coating kit for coating equipment subjected to high wear due to abrasion, corrosion, impact, and chemical attacks, wherein said equipment may be conveyor belts, drums, tanks, impeller pumps, pipes, mills, transfer chutes, etc.

The present invention also protects a metal primer adhesive component, which is part of a coating for repair and/or reconstitution of worn metal areas, applicable on horizontal, vertical and tilted surfaces, which comprises a thermosetting bicomponent (DB1+DB2) or a thermoplastic monocomponent (DM). The thermosetting bicomponent is made up of the first component (DB1) comprising (i) up to 95% of at least a solvent; (ii) up to 5% of at least a pigment, (iii) up to 5% of at least an additive, (iv) up to 25% of a thermoplastic resin, which is selected from phenoxy resin, polyester resin, nitrocellulose resin, CAB/CAP resin, polyurethane resin, phenolic resin, resorcinol resin, methacrylic resin, vinyl resin, polyamide/polyamine resin; (v) up to 10% of an epoxy resin, which is selected from epoxy ester resin, epoxy ether resin, epoxy amino resin, epoxy hydrocarbon/olefin resin, epoxy heterocyclic resin; and a second component (DB2) comprising (i) up to 95% of at least a solvent; (ii) up to 15% of functional (monomeric, polymeric) resins, wherein the functional resin is at least a polyamine, or at least a polysulfide; wherein the thermoplastic monocomponent (DM) comprises (i) up to 95% of at least a solvent; (ii) up to 5% of at least a pigment; (iii) up to 5% of at least an additive; (iv) up to 15% of high molecular weight thermoplastic resins, selected from epoxy resin, phenoxy resin, polyester resin, nitrocellulose resin, CAB/CAP resin, polyurethane resin, resorcinol resin, methacrylic resin, vinyl resins, polyamide resin; and (v) up to 15% of at least a functional (monomeric, polymeric) resin, wherein the functional resin is at least a polyamine, or at least a polysulfide.

Where said first component of the thermosetting bicomponent is preferably epoxy-ether resin.

Where said first component of the thermosetting bicomponent further comprises up to 95% of at least a solvent, optionally pigments and optionally additives.

Where said additives are thickeners and/or accelerants.

Where said second component of the thermosetting bicomponent is a polyamine selected from aliphatic amine, cycloaliphatic amine, and aliphatic amine with a benzene ring.

Aliphatic amine is selected from 1,6-hexamethylene diamine, 1,5-diamine-2-methylpentane, methyl 2,6-diaminehexanoate, 2,2,4-trimethylhexane, 1,6-diamine, 2,4,4-trimethylhexane 1,6-diamine, ethylenediamine, diethylenetriamine, linear and branched triethylenetetramine, tetraethylenepentamine, dipropylenetriamine, dimethylaminepropylamine, N,N′-bis-(2-aminoethyl)piperazine, N-[(2-aminoethyl]piperazine, N-(2-aminoethyl)-N′-[2-aminoethyl]amino)ethyl]1,2-ethanediamine, 4-(2-aminoethyl)-N-(2-aminoethyl)-N′-(2-[2-(2-aminoethyl)amino]ethyl]-1,2-ethanediamine, 1-(2-aminoethyl)-4-[(2-amioneethyl)amino]ethyl]-piperazine), 1-[2-[2-[(2-aminoethyl)amino]ethyl]-piperazine), diethylenediamine, triethylenediamine, tetraethylenediamine, adducts of polyethyleneimines having molecular weight of 400-3,000,000 g/mol reacted with monoepoxies or fatty acids, propylenediamine, dipropylenediamine, tripropylenediamine, tetrapropylenediamine, polypropylenediamine, polyethylene/propylenediamine, polyethylenemonoamine, polyethylene glycol triamine, polypropylene glycol triamine, dimer amine.

Cycloaliphatic amine is selected from 2,5(6)-bis(aminomethyl)bicyclo[2.2.1]heptane; 1,3,3-trimethyl-1-(aminomethyl)-5-aminocyclohexane; 1,8-diamine-2,4-dimethyloctane; octahydro-4,7-methane-1H-indendimethyldiamine; 1,1′-methylenebis(4-aminocyclohexane), bis(aminomethyl)cyclohexane; 1,3-bis(aminomethyl)cyclohexane; bis(aminomethyl)norbornane; n-aminoethylpiperazine.

Aliphatic amine with a benzene ring is selected from 1,4-xylylene diamine (p-xylene diamine); 1,3-xylylene diamine (m-xylene diamine).

The second component of the thermosetting bicomponent is polysulfide, preferably a mercaptan, which is selected from the group consisting of trimethylolpropane tri(3-mercaptopropionate), tris[2-(3-mercaptopropionyloxy)ethyl]isocyanurate, glycol di(3-mercaptopropionate), di-pentaerythritol hexa(3-mercaptopropionate), pentaerythritol tetra(3-mercaptopropionate), ethoxylated trimethylolpropane(3-mercaptopropionate), polycaprolactone tetra(3-mercaptopropionate), 4-(mercaptomethyl)-3,6-dithia-1,8-octanedithiol, 1,2-bis(2-mercaptoethoxy)ethane, 1,2-bis(mercaptomethyl)-1,3-propanediol, 3-mercapto-2,2-bis(mercaptomethyl-1-propanol, 2,2-bis(mercaptomethyl-1,3-propanethiol and 2-ethyl-2-(mercaptomethyl)-1,3-propanethiol.

Said second component of the thermosetting bicomponent optionally comprises at least a solvent, optionally comprises at least a pigment and/or optionally comprises at least an additive that may be thickeners and/or accelerants.

The thermoplastic monocomponent further comprises at least a solvent, at least a pigment and at least an additive, where the additive optionally comprises thickeners and/or accelerants.

The coating kit or chemical system of the present invention provides relevant technical advantages with respect to what is known in the state-of-the-art, among which the following stand out:

### Resin Advantages (Component A):

1. Base resin is formulated to have a pasty consistency with a density of 0.9-1.1 g/cm³, which allows its application on vertical, horizontal and tilted surfaces without runoff.
2. Polymer final hardness—once cured—ranges from 75-90 Shore A at 25° C., allowing a closer resemble with the original rubber coatings used in the industry (pulley coatings for ore transportation systems, tank, centrifugal pump, pulp distributors, conveyor belts coatings, etc.)
3. Base resin retains its liquid/pasty consistency (without crystallizing) at low temperatures (0° C. to 8° C.), which allows its use without having to heat the resin in locations with cold climates such as deserts and mountains.
4. Functional curing speed is adequate for the applicator to cover large coating extensions without hardening of the material during the application process. Additionally, functional curing is fast enough to restart industrial equipment operations within 1 hour from coating application.

### Hardener Advantages (Component B):

1. Pasty consistency with a density of 0.9-1.1 g/cm³ allowing for a better incorporation into a base resin and mixture homogenization, preventing the final coating from being orange-peeled or partially cured.

### Advantages of Rubber Oxidative Primer Adhesive (Component C):

1. Fast drying (1 minute at 23° C.) is achieved.
2. It is compatible with metal primer when applied to surfaces with both substrates (rubber and metal). For surfaces having rubber and metal areas, rubber primer could runoff and touch the metal prior to applying the metal primer. This “contamination” does not affect metal primer binding to the substrate or base resin.

### Advantages of Bi-Component Metal Primer Adhesive (Component D):

1. A functional drying time of 10 minutes is achieved at ambient temperatures between −15 and 40° C.
2. Allows application on substrates exposed to working temperatures from −15 to 130° C.

### Advantages of the Metal Monocomponent Primer Adhesive (Component D)

1. A direct application of the primer adhesive on the metal substrate is achieved, without needing prior mixing.
2. Allows application on substrates exposed to working temperatures from −15 to 80° C.
3. Achieves functional drying in 5 minutes at ambient temperatures between −15 and 40° C.

### Technical Advantages of the Kit or System as a Whole:

1. Large surfaces may be coated at room temperature without the need of heating ingredients.
2. It may be applied on flat, tilted or vertical surfaces, due to its thixotropic characteristics
3. Industrial equipment may be coated on both rubber and metal surfaces thereof, which is the case of a huge variety of industrial equipment (pulleys, pumps, silos, tanks, etc.).
4. The boundary of two substrates (rubber and metal) can be coated without rubber primer “contamination” affecting the metal primer or its binding between substrate and resin.
5. Recovery of thickness of original polyurethane or natural rubber coatings of industrial equipment in situ, without the need to move the equipment to the repair shop or machine shop for its recovery.
6. Fast in situ coating at room temperature of metal equipment exposed to abrasion, oxidation, corrosion and impact.

### Economic Advantages of the Repair System (Coating)

1. Repair and coatings in situ in one hour of work. Lower repair cost compared to other traditional methods.
2. Increased production and useful life of industrial equipment.

Comparative table between the coating kit of the present invention and the reconstitution composition of patent CL 51,001

| | | Technical Advantage of |
|---|---|---|
| System of Patent | Kit or System of the | the Kit or System of |
| CL 51,001 | Present Invention | the Present Invention |
| Liquid resin | Pasty resin | Application on tilted, |
| | | vertical and overhead |
| | | surfaces |
| Resin crystallization | Resin crystallization at | The coating could be |
| at 8° C. | less than 0° C. | applied in geographical |
| | | areas with colder |
| | | climates without the |
| | | need of heating the resin |
| Application only on | Application on rubber, | The system could repair |
| rubber and poly- | polyurethane and | metal equipment and |
| urethane surfaces | metal surfaces | recover rubber and/or |
| | | polyurethane coatings |
| | | at the same time and at |
| | | room temperature |
| No adhesion to | Adhesion from 20 to | High adhesion to metal |
| metal surfaces | 31 N/mm² | surfaces |
| N/A | Metal primer functional | Fast drying of metal |
| | drying of 10 minutes in | primer, which allows |
| | its bicomponent version | resin application 10 |
| | and 5 minutes in its | minutes after starting |
| | monocomponent version | repairing process. |
| Resin gel time of | Resin gel time of 12 | Longer time for applying |
| 8 minutes at 25° C. | minutes at 25° C. | on large surfaces. |
| Coating hardness of | Coating hardness of | It more closely approx- |
| 80-85 Shore A | 75-80 Shore A | imates to the original |
| | | hardness of natural |
| | | rubber coatings used |
| | | for coating equipment |
| | | (pulleys, tanks, |
| | | impellers, conveyor |
| | | belts, etc.) |

### Description of Application and Examples of Repairs STEPS FOR APPLYING THE COMPONENTS OF THE INVENTION KIT

### Preparation of the Formulation for Rubber Surfaces (Substrate):

Scraping using an electric wire brush grinder at low rotational speed (4,800 to 5,600 rpm) over and around the damaged area.
After a porous surface is obtained, proceed to cleaning the area removing all loose rubber pieces and dust on the surface to be repaired. In this step, use the brush or an industrial blower.
Applying the cleaning solvent of the kit of the present invention (component E) on the entire previously prepared area.
Once dry, applying the rubber primer (component C).

### Preparation of the Formulation for Metal Surfaces (Substrates)

Scraping the surface with an abrasive disk until exposure of clean metal. Desired profile is 3-5 mil including sharp edges.
Applying the cleaning solvent (Component E) for removing all traces of oil, grease, dust or other foreign substances resulting from shot-blasting and let it dry.
When using Bi-Component metal primer: Preparing the primer, pouring the entire content of Metal Primer B into the Metal Primer A bottle. Then, close the lid and mix well by shaking the bottle for 30 seconds. NOTE: Once both components are mixed, it will have a 1 hour of pot-life. When using Metal monocomponent primer, open the content and apply according to the next step. Remark: Metal monocomponent primer has no pot-life limitation as long as it is kept in a properly closed container.
For priming the surface, apply a uniform layer of the mixture (for Bicomponent Primer) or MonoComponent Primer and allow to dry according to the drying times established for each case.

### Mixing Resin (Component a) and Hardener (Component B) and Applying Coating.

Pouring the entire content of hardener (Component B) into resin (Component A), mixing vigorously for one minute, using a stirring paddle.
Once having a homogeneous mixture, pour the mixture over the damage and use a spatula for spreading and smoothing the product as needed.
Wait 45 minutes to 1 hour at 23° C./73.4° F. (Caution: for ambient temperatures below 10° C./50° F., wait 1 to 2 hours). After this time, the product will set and hardened, and the equipment will be ready to operate again.

### Application Examples

### Repairing Rubber Coating in Pulleys of Material Conveyor Systems:

Drums or pulleys (drive and idle) used to move a conveyor belt systems in mining are structures made of iron and normally covered in rubber. During the operation of this equipment, the rubber coating wears due to abrasion, losing its thickness, and in many cases even losing the entire coating and exposing pulley metal structure. These damages occur in specific coated areas, leaving the pulley with areas having completely exposed metal, areas having a wear rubber coating (reduced thickness) and areas without damage. This problem is usually solved by removing the pulley from the conveyor system and taking it to a repair shop for rubber sheet coating or hot vulcanizing. This technique forces the productive system to stop for a long time, even in the case of having a new replacement pulley, since the process of removing the old pulley and installing the new pulley is slow and complex. In addition, this solution requires removing the entire old coating for applying a complete coating on the pulley—even in those areas without damage—. This process that can take several days of work.

This problem is solved by the present invention, which allows reconstitution of the rubber coating in situ (without removing the pulley), applying the chemical preparation directly on both metal substrate areas (areas where the rubber coating was completely lost), and rubber substrate areas (areas needing to recover the thickness of the worn coating). Due to resin thixotropic pasty consistency, this coating may be applied easily and without runoff, regardless of the cylindrical shape of the equipment.

Repair of Conveyor Belts with Exposed Steel Cord Cores:

Conveyor belts in mining industry suffer damage due to impact, abrasion or corrosion produced by rocks on its surface, resulting in cuts and tears of great magnitude. Many of these conveyor belts are made of rubber and reinforced with a core of braided steel cord filaments.

They are repaired using fastening staples, cold vulcanization, hot splicing or definitive belt changes, depending on the magnitude of the damage. These solutions, in addition to being expensive, require quite a lot of personnel and quite long plant shutdown times, which significantly decrease mining plant productivity. (For example, splicing requires about twelve people, an average of ten hours and large vulcanizing machinery).

Although there are chemical preparations that may be used for repairing this type of damage, these have certain limitations, namely: (resin) coatings currently applied have liquid and non-thixotropic consistency, limiting their application to horizontal or slight tilted surfaces and making very difficult, if not impossible, their application on surfaces having high degree of tilting or overhead and, on the other hand, said coatings only have adhesion to the rubber substrate, so they would only achieve a good performance on that substrate, and not on the exposed steel cords (metal substrate), causing detachment of the coating at said points.

This problem is solved by the present invention, which allows reconstitution of conveyor belt coating in situ, applying the chemical preparation indistinctly on both substrates (metal and rubber), without risking detachment due to lack of adhesion. In addition, due to resin thixotropic pasty consistency, damage at any position on the belt—horizontal, vertical surfaces or overhead—can be repaired, without being forced to constantly move the conveyor belt to expose damages in horizontal position. Damages can be repaired without losing material (runoff) regardless of damage position and without the need to reposition the conveyor belt.

### EXAMPLES OF FORMULATIONS

The following formulations were prepared.

### Example 1

Kit or Chemical System with Metal Bicomponent Primer:

| RESIN/COMPONENT A | % |
|---|---|
| PPG/mdi prepolymer having 3.1-6.2% NCO | 90-60 |
| N-butyl acetate | 9-18 |
| Methyl ethyl ketone | 0-2 |
| Dispersed black smoke | 1-12 |
| Polydimethylsiloxane at 1-10% in hydrocarbons | 0-4 |
| Fumed silica | 0-4 |
| | 100.0 |
| HARDENER/CATALYST/COMPONENT B | |
| Isoamyl acetate | 15-30 |
| (aromatic polyamine)-2-ethyl 1,3-diaminobenzene | 65-40 |
| Surface modified rutile titanium dioxide | 10-05 |
| Aluminum/calcium/magnesium silicate fibers | 19-25 |
| | 100 |
| RUBBER MONOCOMPONENT PRIMER/ | |
| COMPONENT C | |
| Propyl acetate | 98-90 |
| 3-dibromo-5,5-dimethyl-hydantoin | 2-10 |
| | 100 |
| METAL PRIMER A/COMPONENT DB1 | |
| Methyl ethyl ketone | 65-80 |
| Phenoxy resin (molecular weight > 10,000 g/mol) | 30-10 |
| Bisphenol-F epoxy resin (EEW > 170 g/mol) | 5-9 |
| 4′-(N,N-diethylamino)-(1E)-diphenyldiazene | 0-1 |
| | 100 |
| METAL PRIMER B/COMPONENT DB2 | |
| 1,2-bis(mercaptomethyl)-1,3-propanediol | 5-10 |
| Tetrahydrofuran | 95-89 |
| 1,4-Diazabicyclo[2.2.2]octane | 0-1 |
| | 100 |
| CLEANING SOLVENT/COMPONENT E | |
| Ethyl acetate | 100.0 |
| | 100.0 |

### Example 2

Kit or Chemical System with Metal Bicomponent Primer:

| RESIN/COMPONENT A | % |
|---|---|
| Pre-polymer PPG/TDI with 3.1-6.2% NCO | 90-60 |
| Methyl isobutyl ketone | 9-18 |
| Tetrahydrofuran | 0-2 |
| Disperse black smoke | 1-12 |
| Polydimethylsiloxane at 1-10% in hydrocarbons | 0-4 |
| Fumed silica | 0-4 |
| | 100.0 |
| HARDENER/CATALYST/COMPONENT B | |
| methyl isobutyl ketone | 15-30 |
| (Aromatic polyamine)-4,4′-methylene- | 65-40 |
| bis-(2-ethyl-6-methylaniline) | |
| Surface modified rutile titanium dioxide | 10-5 |
| Polyamide fibers | 19-25 |
| | 100 |
| RUBBER MONOCOMPONENT PRIMER | |
| COMPONENT C | |
| Ethyl acetate | 98-90 |
| Hydrogen peroxide | 2-10 |
| | 100 |
| METAL PRIMER A/COMPONENT DB1 | |
| Isopropyl acetate | 65-80 |
| Phenoxy resin (molecular weight > 10,000 g/mol) | 30-10 |
| Bisphenol-A epoxy resin (EEW > 170 g/mol) | 5-9 |
| 4′-(N,N-diethylamino)-(1E)-diphenyldiazene | 0-1 |
| | 100 |
| METAL PRIMER B/COMPONENT DB2 | |
| 1,2-bis(mercaptomethyl)-1,3-propanediol | 5-15 |
| Ethyl acetate | 95-84 |
| 1,4-Diazabicyclo[2.2.2]octane | 0-1 |
| | 100 |
| CLEANING SOLVENT/COMPONENT E | |
| Methyl ethyl ketone | 100.0 |
| | 100.0 |

### Example 3

Kit or Chemical System with Metal Bicomponent Primer:

| RESIN/COMPONENT A | % |
|---|---|
| PPG prepolymer/TDI with 3.1-6.2% NCO | 90-60 |
| Methyl isobutyl ketone | 9-18 |
| Methyl ethyl ketone | 0-2 |
| Dispersed black smoke | 1-12 |
| Polydimethylsiloxane at 1-10% in hydrocarbons | 0-4 |
| Fumed silica | 0-4 |
| | 100.0 |
| HARDENER/CATALYST/COMPONENT B | |
| Isoamyl acetate | 15-30 |
| (Aromatic polyamine)-3,5-diethyltoluene-2,4diamine | 65-40 |
| Surface Modified Rutile Titanium Dioxide | 1-5 |
| Aluminum/Calcium/Magnesium Silicate Fibers | 19-25 |
| | 100 |
| RUBBER MONOCOMPONENT PRIMER | |
| COMPONENT C | |
| Ethyl acetate | 98-90 |
| Trichloroisocyanuric acid | 2-10 |
| | 100 |
| METAL PRIMER A/COMPONENT DB1 | |
| Tetrahydrofuran | 65-80 |
| Phenoxy resin (molecular weight > 10,000 g/mol) | 30-10 |
| Novolac epoxy resin (EEW > 170 g/mol) | 5-9 |
| 4′-(N,N-diethylamino)-(1E)-diphenyldiazene | 0-1 |
| | 100 |
| METAL PRIMER B/COMPONENT DB2 | |
| Triethylenediamine | 15-1 |
| Methyl ethyl ketone | 85-99 |
| | 100 |
| CLEANING SOLVENT/COMPONENT E | |
| Ethyl acetate | 100.0 |
| | 100.0 |

This type of system mixing component A+B has a pot-life at 25° C. of about 1-12 minutes. Final hardness will be 75-80 Shore A. Adhesion to rubber will be about 15-22 N/mm², abrasion resistance=50-80 mm³, elongation 300-450%, tear resistance 700-1000 PLI, Modulus 100%=1,000-2,000 PSI and 300%=2,000-3,500 PSI. Metal adherence will be 14-50 N/mm².

### Example 4

Kit or Chemical System with Metal Monocomponent Primer:

| RESIN/COMPONENT A | % |
|---|---|
| PTMEG/MDI prepolymer with 3.1-6.2% NCO | 90-60 |
| Isoamyl acetate | 9-18 |
| Methyl ethyl ketone | 0-2 |
| Dispersed black smoke | 1-12 |
| Polydimethylsiloxane at 1-10% in hydrocarbons | 0-4 |
| Fumed silica | 0-4 |
| | 100 |
| HARDENER/CATALYST/COMPONENT B | |
| Isoamyl acetate or Methyl isobutyl ketone | 15-30 |
| (Aromatic polyamine 4,4′-methylene-bis- | 65-40 |
| (3-chloro-2,6-diethylamine | |
| Surface Modified Rutile Titanium Dioxide | 1-5 |
| Cotton fibers | 19-25 |
| | 100 |
| RUBBER MONOCOMPONENT PRIMER/ | |
| COMPONENT C | |
| Propyl acetate | 98-90 |
| 3-dibromo-5,5-dimethyl-hydantoin | 2-10 |
| | 100 |
| METAL MONOCOMPONENT PRIMER/ | |
| COMPONENT DM | |
| Methyl ethyl ketone | 70-95 |
| Phenoxy resin (molecular weight >10,000 g/mol) | 25-4 |
| Polyamine functional resin (molecular | 4-1 |
| weight > 10,000 g/mol) | |
| 4′-(N,N-diethylamino)-(1E)-diphenyldiazene | 1-0 |
| | 100 |
| SOLVENT/COMPONENT E | |
| Ethyl acetate | 100 |
| | 100 |

### Example

Kit or Chemical System with Metal Monocomponent Primer:

| RESIN/COMPONENT A | % |
|---|---|
| PPG/MDI prepolymer with 3.1-6.2% NCO | 90-60 |
| Isoamyl acetate | 9-18 |
| Methyl ethyl ketone | 0-2 |
| Dispersed black smoke | 1-12 |
| Polydimethylsiloxane at 1-10% in hydrocarbons | 0-4 |
| Fumed silica | 0-4 |
| | 100 |
| HARDENER/CATALYST/COMPONENT B | |
| Butyl acetate | 15-30 |
| (Aromatic polyamine) 4,4′-methylene- | 65-40 |
| bis(2,3-dichloroaniline) | |
| Surface Modified Rutile Titanium Dioxide | 1-5 |
| Aluminum/Calcium/Magnesium Silicate Fibers | 19-25 |
| | 100 |
| RUBBER MONOCOMPONENT PRIMER/ | |
| COMPONENT C | |
| Butyl acetate | 98-90 |
| MEK peroxide | 2-10 |
| | 100 |
| METAL MONOCOMPONENT PRIMER/ | |
| COMPONENT DM | |
| Methyl ethyl ketone | 70-95 |
| Polyester resin (molecular weight > | 25-4 |
| 10,000 g/mol) | |
| Polysulfide functional resin (Molecular | 4-1 |
| weight > 10,000 g/mol) | |
| 4′-(N,N-diethylamino)-(1E)-diphenyldiazene | 1-0 |
| | 100 |
| SOLVENT/COMPONENT E | |
| Propyl acetate | 100 |
| | 100 |

### Example 6

Kit or Chemical System with Metal Monocomponent Primer:

| RESIN/COMPONENT A | % |
|---|---|
| PPG/MDI prepolymer with 3.1-6.2% NCO | 90-60 |
| Methoxy propyl acetate | 9-18 |
| Tetrahydrofuran | 0-2 |
| Dispersed black smoke | 1-12 |
| Polydimethylsiloxane at 1-10% in hydrocarbons | 0-4 |
| Fumed silica | 0-4 |
| | 100 |
| HARDENER/CATALYST/COMPONENT B | |
| Isoamyl acetate | 15-30 |
| (aromatic polyamine) 3,5-dimethylthio2,4- | 65-40 |
| toluenediamine | |
| Surface Modified Rutile Titanium Dioxide | 1-5 |
| Aluminum/Calcium/Magnesium Silicate Fibers | 19-25 |
| | 100 |
| RUBBER MONOCOMPONENT PRIMER/ | |
| COMPONENT C | |
| Ethyl acetate | 98-90 |
| Trichloroisocyanuric acid | 2-10 |
| | 100 |
| METAL MONOCOMPONENT PRIMER/ | |
| COMPONENT DM | |
| Ethyl acetate | 70-95 |
| Acrylic resin (molecular weight > 20000 g/mol) | 25-4 |
| Amino functional resin (molecular weight > | 4-1 |
| 10,000 g/mol) | |
| 4′-(N,N-diethylamino)-(1E)-diphenyldiazene | 1-0 |
| | 100 |
| SOLVENT/COMPONENT E | |
| Methyl ethyl ketone or ethyl acetate | 100 |
| | 100 |

This type of system having a mixture of component A+B has a pot-life at 25° C. of about 1-12 minutes. Final hardness will be 75-90 Shore A. Adhesion to rubber will be about 15-22 N/mm², abrasion resistance=50-80 mm³, elongation 300-450%, tear resistance 700-1000 PLI, Modulus 100%=1,000-2,000 PSI and 300%=2,000-3,500 PSI. Metal adherence will be 14-50 N/mm².

The scope of the coating kit described in the present invention is not limited to the components included herein, but rather encompass any component or system intended for coating worn surfaces that includes the components comprised by the kit or the metal primer adhesive component disclosed in the present invention.

1. Coating kit for repair and/or reconstitution of rubber and/or metal worn areas, applicable on horizontal, vertical or tilted surfaces, the coating kit comprising:
a component A, main resin, which is a base composition comprising:
(i) up to 90% of a polyurethane prepolymer having free isocyanate groups;
(ii) up to 25% solvents;
(iii) up to 35% of at least a pigment;
(iv) up to 10% of at least an additive; and
a component B, hardener, which is a mixture comprising:
(i) up to 90% of at least a monomeric or polymeric aromatic polyamine;
(ii) up to 50% of at least a solvent;
(iii) up to 35% pigment; and
(iv) up to 35% additives;
* a component C, composed of:
(i) up to 10% of a rubber oxide primer adhesive, which is selected between an organic oxidant and an inorganic oxidant, wherein:
the organic oxidant is selected from hydantoins and organic peroxides; and
the inorganic oxidant is selected from mono-, di- and tri chloroisocyanuric acid, hydrogen peroxide, ammonium/sodium/potassium persulfate and chlorine dioxide; and
(ii) up to 99.5% of at least a solvent;
a component D, metal primer adhesive, comprising a thermosetting bicomponent (DB) or a thermoplastic monocomponent (DM), wherein:
The thermosetting bicomponent is made up of 2 components:
First component (DB1), comprising:
(i) up to 95% of at least a solvent;
(ii) up to 5% of at least a pigment;
(iii) up to 5% of at least an additive;
(iv) up to 25% of a thermoplastic resin, which is selected from phenoxy resin, polyester resin, nitrocellulose resin, CAB/CAP resin, polyurethane resin, phenolic resin, resorcinol resin, methacrylic resin, vinyl resin, polyamide/polyamine resin;
(v) up to 10% of an epoxy resin, which is selected from epoxy-ester resin, epoxy-ether resin, epoxy amino resin, epoxy hydrocarbon/olefin resin, epoxy heterocyclic resin; and
Second component (DB2), comprising:
(i) up to 90% of at least a solvent;
(ii) up to 5% of at least an additive:
(iii) up to 15% of functional (monomeric, polymeric) resins, wherein the functional resin is at least a polyamine, or at least a polysulfite;
and wherein,
the thermoplastic monocomponent (DM), comprises:
(i) up to 95% of at least a solvent;
(ii) up to 5% of at least a pigment;
(iii) up to 5% of at least an additive;
(iv) up to 15% of high molecular weight thermoplastic resins, selected from epoxy resin, phenoxy resin, polyester resin, nitrocellulose resin, CAB/CAP resin, polyurethane resin, resorcinol resin, methacrylic resin, vinyl resin, polyamide resin; and
(v) up to 15% of at least a functional (monomeric, polymeric) resin, wherein the functional resin is at least a polyamine, or at least a polysulfite; and
a component E, which is an oxygenated and/or hydrocarbon cleaning solvent.

2. The coating kit according to claim 1, wherein when the first component of the thermosetting bicomponent is an epoxy resin, it is preferably epoxy-ether resin.

3. The coating kit according to claim 1, wherein the first component of the thermosetting bicomponent also comprises up to 95% of at least a solvent, up to 5% of at least a pigment, up to 5% of at least an additive, up to 25% of at least a thermoplastic resin, up to 10% of at least a functional epoxy resin.

4. The coating kit according to claim 3, wherein the additives are thickeners and/or accelerants.

5. The coating kit according to claim 1, wherein the second component of the thermosetting bicomponent is a polyamine selected from aliphatic (monomeric/polymeric) amine, cycloaliphatic amine and aliphatic amine with a benzene ring.

6. The coating kit according to claim 5, wherein the aliphatic amine is selected from 1,6-hexamethylene diamine, 1, 5-diamine-2-m ethylpentane, methyl 2.6-diaminehexanoate, 2,2,4-trimethylhexane 1,6-diamine, 2,4,4-trimethylhexane 1.6-diamine, ethylenediamine, di ethylenetriamine, linear and branched triethylenetetramine, tetraethylenepentamine, dipropylenetriamine, dimethylaminepropylamine, N,N′-bis-(2-aminoethyl)piperazine, N-[(2-aminoethyl]piperazine, N-(2-aminoethyl)-N′-[2-aminoethyl]amino)ethyl]1,2-ethanediamine, 4-(2-aminoethyl)-N-(2-aminoethyl)-N′-(2-[2-(2-aminoethyl)amino]ethyl]-1,2-ethanediamine, l-(2-aminoethyl)-4-[(2-aminoethyl)amino]ethyl]-piperazine), 1-[2-[2-[(2-aminoethyl)amino]ethyl]-piperazine), diethylenediamine, triethylenediamine, tetraethylenediamine, adducts of polyethyleneimines having molecular weight 400-3,000,000 g/mol reacted with monoepoxies or fatty acids, propylenediamine, dipropylenediamine, tripropylenediamine, tetrapropylenediamine, polypropylenediamine, polyethylene/propylenediamine, polyethylene monoamine, polyethylene glycol triamine, polypropylene glycol triamine, and dimer amine.

7. The coating kit according to claim 5, wherein the cycloaliphatic amine is selected from 2,5(6)-bis(aminomethyl)bicyclo[2.2.1]heptane, 1,3,3-trimethyl-1-(aminomethyl)-5-aminocyclohexane, 1,8-diamine-2,4-dimethyloctane, octahydro-4,7-methane-IH-indendimethyl diamine, 1,1′-methylenebis(4-aminocyclohexane), bis(aminomethyl)cyclohexane, 1,3-bis(aminomethyl)cyclohexane, bis(aminomethyl)norbornane, and n-aminoethylpiperazine.

8. The coating kit according to claim 5, wherein the aliphatic amine with a benzene ring is selected from 1,4-xylylene diamine (p-xylene diamine) and 1,3-xylylene diamine (m-xylene diamine).

9. The coating kit according to claim 1, wherein the second component of the thermosetting bicomponent is a polysulfite, preferably a mercaptan.

10. The coating kit according to claim 9, wherein the mercaptan is selected from the group consisting of trimethylolpropane tri(3-mercaptopropionate), tris[2-(3-mercaptopropionyloxy)ethyl]isocyanurate, glycol di(3-mercaptopropionate), di-pentaerythritol hexa(3-mercaptopropionate), pentaerythritol tetra(3-mercaptopropionate), ethoxylated trimethylolpropane (3-mercaptopropionate), polycaprolactone tetra(3-mercaptopropionate), 4-(mercaptomethyl)-3,6-dithia-1,8-octanedithiol, 1,2-bis(2-mercaptoethoxy)ethane, 1,2-bis(mercaptomethyl)-1,3-propanediol, 3-mercapto-2,2-bis(mercaptomethyl-1-propanol,2,2-bis(mercaptomethyl-1,3-propanethiol and 2-ethyl-2-(mercaptomethyl)-1,3-propanethiol.

11. The coating kit according to claim 1, wherein the second component of the thermosetting bicomponent comprises at least a solvent.

12. The coating kit according to claim 1, wherein the second component of the thermosetting bicomponent comprises at least a pigment.

13. The kit according to claim 1, wherein the second component of the thermosetting bicomponent comprises at least an additive.

14. The kit according to claim 13, wherein the at least an additive is thickener and/or accelerant.

15. The coating kit according to claim 1, wherein the thermoplastic monocomponent further comprises at least a solvent, at least a functional epoxy resin, at least a pigment and at least an additive.

16. The kit according to claim 15, wherein the additive optionally comprises thickeners and/or accelerants.

17. The coating kit according to claim 1, wherein the aromatic diamine of component B is selected from monomeric polyamine and polymeric/oligomeric polyamine.

18. The kit according to claim 17, wherein the monomeric polyamine is selected from the group consisting of 2,4 with 2,6 isomers of DETDA (diethyltoluenediamine), methylenebis(N,N-dibutyldianiline), 3,5-dimethylthio-2,4-toluenediamine, 3,5-dimethylthio-2,6-toluenediamine, methylene dianiline (MDA), 4,4′-methylene-bis-(2-ethyl-6-methylaniline) (MMEA), 4,4′-bis-(2,6-di ethylaniline) (MDEA), 4,4′-methylene-bis-(2-isopropyl-6-methylaniline) (MMIPA), 4,4′-bis(sec-butylamino)diphenylmethane, phenylenediamine, methylene-bis-orthochloroaniline (MBOCA), 4, 4′-methylene-bis-(2-methylaniline) (MMA), 4,4′-methylene-bis-(2-chloro-6-ethylaniline) (MCEA), 1,2-bis(2-amino-phenylthio)ethane, 4,4′-methylene-bis(2,6-diisopropylaniline) (MDIPA), Dimethylthio toluenediamine (DMTDA), 2-ethyl 1,3-diaminobenzene, 1-methyl-3.5-diethyl-2,4-diaminobenzene, 1-methyl-3, 5-di ethyl 2,6-diaminobenzene, 1,3,5-triethyl-2,4-diaminobenzene, 4,4′-Methylenebis(2-chloroaniline), N,N′-di-sec-butyl-p-phenylene-diamine, Bis(N-sec-butyl-p-aminophenyl)methane, 4′, 4′-diamino diphenylmethane, 3,5-diamino-4-chloro-benzoic acid isobutyl ester, N,N′-Bis(1-methylpropyl)-1,4-phenylenediamine, 4,4′-Methylene-bis(N-sec-butylaniline), 4-chloro-3, 5-diethyltoluene-2,6-diamine, 6-chloro-3,5-diethyltoluene-2,4-diamine, 4,4′bis-(secbutylamine)dichlorohexylmethane (SBADCHM), 4,4′bis-(secbutylamine)diphenylmethane (SBADFM), methylene bis-o-chloro-aniline (MOCA), isobutyl-3, 5-diamino-4-chlorobenzoate, trimethylene glycol-di-p-aminobenzoate (TMGDAB), 4,4′-methylene-bis-(3-chloro-2,6-diethylamine (MCDEA), 4,4′-methylene-bis(2-chloroaniline), 4,4′-methylene-bis(2,3-dichloroaniline) (TCDAM), 4,4′-methylene-bis(2,5-dichloroaniline), 4, d′methylene-bis(2-ethylaniline), 4, 4′-methylene-bis(2-isopropylaniline), dimer-bis-(4-aminobenzoate, 4, 4′-methylene-bis(2,6-di ethylaniline), 4,4′-methylene-bis(2-ethyl-6-methylaniline), 4, 4′-methylene-bis(2-chloro-6-methyl aniline), 4, d′methylene-bis(2-chloro-6-ethylaniline), 4,4′-methylene-bis(3-chloro-2,6-diethylaniline), 4, 4′-methylene-bis(2-trifluoromethyl aniline), 4,4′-diaminodiphenyl ether, 4, 4′-diamino-3, 3′-di chlorodiphenyl ether, 4,4′-diaminodiphenyl sulfone, 4,4′-diamino-3,3′-dichlorodiphenyl sulfone; bis(4-aminophenoxyphenyl)sulfone; 1,2-bis(2-aminophenylthio)ethane, bis-(2-(2-aminophenothio)ethyl)terephthalate; 1,3-propanediol bis(4-aminobenzoate), 1,4-butanediol bis(4-aminobenzoate), diethyleneglycol bis(4-aminobenzoate), triethyleneglycol bis(4-aminobenzoate, 4-chloro-3,5-diamino isopropylbenzoate, 4-chloro-3,5-diamino isobutylbenzoate, 3,5-diethyl-2,4-toluenediamine, 3,5-diethyl-2,6-toluenediamine, 3,5-dimethylthio2,4-toluenediamine, 3,5-dimethylthio-2,6-toluenediamine, 2,2-bis(4-aminophenyl)propane, 2,2-bis(4-amino-3-methylphenyl)propane, 2,2-bis(4-amino-3-ethylphenyl)propane, 2,2-bis(4-amino-3-isopropylphenyl)propane, 2,2-bis(4-amino-3,5-moeda thylphenyl)propane, 2,2-bis(4-amino-3,5-diethylphenyl)propane, 2,2bis(4-amino-3,5-diisopropylphenyl)propane and 2,2-bis(4-amino-3-ethyl-5-diethylphenyl)propane.

19. The coating kit according to claim 17, wherein the polymeric/oligomeric polyamine is selected from the group consisting of poly(ethylene glycol)bis(4-aminobenzoate), polypropylene glycol)bis(4-aminobenzoate), poly (tetramethylene glycol)bis(4-aminobenzoate) and poly(butylene glycol)bis(4-aminobenzoate).

20. The coating kit according to claim 1, wherein the additives of component B may be thickeners and/or accelerants.

21. The coating kit according to claim 20, wherein the additives of component B are selected from disperse polyurea, polyurethanes, high molecular weight polymers, barium, magnesium, calcium sulfonates, hydrophilic fumed silicas, non-surface modified fumed silicon oxide, hydrophobic fumed silica, fumed silicon oxide surface-modified with organic silanes/polysiloxanes, magnesium silicates, natural talc, aluminum, calcium, potassium and sodium bentonites, calcium-magnesium silicate/aluminate-based inorganic fibers, cotton fibers-based organic fibers, polyester, polyamide.

22. The coating kit according to claim 1, wherein component B optionally comprises at least a solvent and/or at least a pigment.

23. The coating kit according to claim 1, wherein the oxygenated cleaning solvent of component E is selected from:
esters, such as methyl acetate, ethyl acetate, n-propyl acetate, isopropyl acetate, n-butyl acetate, sec-butyl acetate, isobutyl acetate, tert-butyl acetate, n-pentyl acetate, isopentyl or isoamyl acetate;
ketones, such as acetone, methyl ethyl ketone, methyl isobutyl ketone, methyl isoamyl ketone, methyl n-propyl ketone; and
ethers, such as tetrahydrofuran.

24. The coating kit according to claim 1, wherein the hydrocarbon cleaning solvent of component E is selected from toluene, xylol, diethyl benzene, triethyl benzene, cyclohexane and n-hexane.

25. The coating kit according to claim 1, wherein the solvent is selected from oxygenated solvents, hydrocarbon solvents and mixtures thereof.

26. The coating kit according to claim 25, wherein the solvent is selected from:
esters, such as methyl acetate, ethyl acetate, n-propyl acetate, isopropyl acetate, n-butyl acetate, sec-butyl acetate, isobutyl acetate, tert-butyl acetate, n-pentyl acetate, isopentyl or isoamyl acetate, n-hexyl acetate, 2-ethyl hexyl acetate, cyclohexyl acetate, methoxypropyl acetate, butyl glycol acetate, ethyl glycol acetate, ethoxypropyl acetate, butoxypropyl acetate, dimethyl ester, phenyl glycol acetate, and phenoxypropyl acetate;
ketones, such as, acetone, methyl ethyl ketone, methyl n-amyl ketone, methyl isobutyl ketone, methyl isoamyl ketone, isophorone, cyclohexanone, acetophenone and methyl n-propyl ketone;
carbonates, such as, dimethyl carbonate, diethyl carbonate, di-n-propyl carbonate, diisopropyl carbonate, di-n-butyl carbonate, di-sec-butyl carbonate, di-tert-butyl carbonate, di-isobutyl carbonate, di-n-pentyl carbonate, di-2-ethyl-hexyl carbonate, diphenyl carbonate and dibenzyl carbonate;
ethers, such as, tetrahydrofuran, dimethyl ether, diethyl ether and dipropyl ether;
amides, such as n-methyl pyrrolidone, n-ethyl pyrrolidone, n-propyl pyrrolidone, n-butyl pyrrolidone, n-hexyl pyrrolidone, dimethyl formamide and dimethyl acetamide;
aromatics, such as, toluene, xylol, diethyl benzene and triethyl benzene.

27. Coating kit according to claim 4, wherein the additive is selected between thickeners and/or accelerants.

28. The coating kit according to claim 27, wherein the accelerant is selected from 1,4-diazabicyclo[2.2.2]octane (DABCO), 1,8-diazabicyclo[5.4.0]undec-7-ene (DBU), 2,4,6-tris(dimethylaminomethyl)phenol or 2,4-bis(dimethylaminomethyl)phenol.

29. The coating kit according to claim 1, wherein the additive of component A is selected from thickener, moisture absorbers and defoamer.

30. The coating kit according to claim 29, wherein the thickener is selected from disperse polyurea, polyurethanes, high molecular weight polymers, barium, magnesium, calcium sulfonates, hydrophilic fumed silicas, non-surface modified fumed silicon oxide, hydrophobic fumed silica, fumed silicon oxide surface-modified with organic silanes/polysiloxanes, magnesium silicates, natural talc, aluminum, calcium, potassium and sodium bentonites, calcium-magnesium silicate/aluminate-based inorganic fibers, cotton fibers-based organic fibers, polyester, polyamide.

31. The coating kit according to claim 29, wherein the defoamer is selected from hexane, heptane, decane, isooctane, polydimethylsiloxane, liquid fluorocarbon, hexafluor obenzene, octafluorotoluene, octafluoronaphthalene, fluorinated alkyl (meth)acrylates and fluorinated aryl (meth)acrylates.

32. The kit according to claim 29, wherein the moisture absorber is selected from calcium chlorate, calcium sulfate, zeolite powder with pores of 3 to 4 A, 4-methylbenzenesulfonylisocyanate, o-ethoxy carbonyl benzene sulfonyl isocyanate and 2,4-dichlorobenzene-1-sulfonyl isocyanate.

33. The coating kit according to claim 1, wherein each one of the components A, B, C, D and E are in separate containers.

34. The coating kit according to claim 1, wherein the polyurethane prepolymer (polyurethane resin) is a structure of small molecular size (low molecular weight around 400-4,200 g/mol) produced by reaction of a polyol (polyester, polyether (PPG, PEG, PTMG and mixtures), polycarbonates, polycaprolactones) with an excess of (aromatic (TDI, MDI PDI), aliphatic (HDI) and cycloaliphatic (IPDI, HDMI)) polyisocyanate, to get a final product having 2-10% of free NCO groups.

35. Method for coating a worn metal surface, the method comprising the steps of:
scraping the worn surface with an abrasive disk until the surface is clean and porous;
applying an oxygenated or hydrocarbon solvent (component E), for removing all traces of oil, grease, dust or other foreign substances resulting from shot-blasting, and allow to dry;
preparing the bicomponent thermosetting primer adhesive (component D), which is made up of a first and second component, each one in a separate container, emptying the container of the second component and transferring its content into the container of the first component, to obtain a mixture inside the container of the first component, then closing the container containing the mixture with a lid, shaking the obtained mixture for 30 seconds; or
opening the container of the monocomponent thermoplastic primer adhesive;
applying the primer adhesive from the previous step as a uniform layer onto the metal surface to be treated, and let it dry;
pouring the mixture of at least an aromatic diamine and additives (component B) into the container of the base composition comprising a polyurethane prepolymer having free isocyanate groups, solvents, pigment, and an additive (component A), stirring for one minute until a homogeneous mixture is obtained;
spreading said homogeneous mixture from the previous step on the worn metal surface, using a spatula to spread and smooth the homogeneous mixture on the surface; and
waiting for a time from 45 to 60 minutes at a temperature about 23° C., until the product on the worn surfaces has set and hardened.

36. Method for coating a worn or damaged metal and rubber surface, the method comprising:
scraping the worn metal surface with an abrasive disk until the surface is clean and porous;
scraping the worn rubber surface with an electric grinder with a wire brush until it is clean and porous;
applying an oxygenated or hydrocarbon solvent (component E) on the scrapped metal surface and on the rubber surface, for removing all traces of oil, grease, foreign material, dust or other substances resulting from the shot-blasting, and allow to dry;
preparing the bicomponent thermosetting primer adhesive (component D), which is made up of a first and second component, each one in a separate container, emptying the container of the second component and transferring its content into the container of the first component, to obtain a mixture inside the container of the first component, then closing the container containing the mixture with a lid, shaking the obtained mixture for 30 seconds; or opening the container of the monocomponent thermoplastic primer adhesive;
applying the primer adhesive from the previous step as a uniform layer onto the metal surface to be treated, and let it dry;
applying the mixture of rubber oxide primer adhesive and solvent (component C) on the rubber surface to be treated, and allow to dry;
pouring the mixture of at least an aromatic diamine and additives (component B) into the container of the base composition comprising a polyurethane prepolymer having free isocyanate groups, solvents, pigment, and an additive (component A), stirring for one minute until a homogeneous mixture is obtained;
spreading said homogeneous mixture from the previous step on the worn metal surface, using a spatula to spread and smooth the homogeneous mixture on the surface; and
waiting for a time from 20 to 60 minutes at a temperature about 23° C., until the product on the worn surfaces has set and hardened.

37-38. (canceled)

39. Metal primer adhesive component, for repair and/or reconstitution of worn rubber and metal areas, applicable on horizontal, vertical and tilted surfaces, the metal primer adhesive component comprising a thermosetting bicomponent or a thermoplastic monocomponent, wherein:
The thermosetting bicomponent is made up of:
a first component comprising up to 95% of at least a solvent, up to 5% of at least a pigment, up to 5% of at least an additive, up to 25% of a thermoplastic resin, which is selected from phenoxy resin, polyester resin, nitrocellulose resin, CAB/CAP resin, polyurethane resin, phenolic resin, resorcinol resin, methacrylic resin, vinyl resin, polyamide/polyamine resin; and up to 10% of an epoxy resin, which is selected from epoxy ester resin, epoxy ether resin, epoxy amino resin, epoxy hydrocarbon/olefin resin, epoxy heterocyclic resin; and
a second component comprising up to 90% of at least a solvent, up to 5% of at least an additive, up to 15% of functional (monomeric or polymeric) resins, where the functional resin is at least a polyamine selected from aliphatic amine, cycloaliphatic amine and aliphatic amine with benzene ring, or at least a polysulfite;
and wherein,
the thermoplastic monocomponent comprises
up to 95% of at least a solvent;
up to 5% of at least a pigment;
up to 5% of at least an additive;
up to 15% of high molecular weight thermoplastic resins, selected from epoxy resin, phenoxy resin, polyester resin, nitrocellulose resin, CAB/CAP resin, polyurethane resin, resorcinol resin, methacrylic resin, vinyl resins, polyamide resin;
and up to 15% of at least a functional (monomeric, polymeric) resin, wherein the functional resin is at least a polyamine, or at least a polysulfite.

40. The metal primer adhesive component according to claim 39, wherein the first component of the thermosetting bicomponent is preferably epoxy-ether resin.

41. The metal primer adhesive component according to claim 39, wherein the first component of the thermosetting bicomponent further comprises up to 95% of at least a solvent, up to 5% of at least a pigment, up to 5% of at least an additive, up to 25% of at least a thermoplastic resin and up to 10% of at least a functional epoxy resin.

42. The metal primer adhesive component according to claim 39, wherein the additives are thickeners and/or accelerants.

43. (canceled)

44. The metal primer adhesive component according to claim 2, wherein the aliphatic amine is selected from 1,6-hexam ethylene diamine, 1,5-diamine-2-methylpentane, methyl 2,6-diaminehexanoate, 2,2,4-trimethylhexane-1,6-diamine, 2,4,4-trimethylhexane-1,6-diamine, ethylenediamine, diethylenetriamine, linear and branched triethylenetetramine, tetraethylenepentamine, dipropylenetriamine, dimethylaminepropylamine, N,N-bis-(2-aminoethyl)piperazine, N-[(2-aminoethyl]piperazine, N-(2-aminoethyl)-N′-[2-aminoethyl]amino)ethyl]1,2-ethanediamine, 4-(2-aminoethyl)-N-(2-aminoethyl)-N′-(2-[2-(2-aminoethyl)amino]ethyl]-1,2-ethanediamine, 1-(2-aminoethyl)-4-[(2-aminoethyl)amino]ethyl]-piperazine), 1-[2-[2-[(2-aminoethyl)amino]ethyl]-piperazine), diethylenediamine, triethylenediamine, tetraethylenediamine, adducts of polyethyleneimines having molecular weight 400-3,000,000 g/mol reacted with monoepoxies or fatty acids, propylenediamine, dipropylenediamine, tripropylenediamine, tetrapropylenediamine, polypropylenediamine, polyethylene/propylenediamine, polyethylenemonoamine, polyethylene glycol triamine, polypropylene glycol triamine, and dimer amine.

45. The metal primer adhesive component according to claim 39, wherein the cycloaliphatic amine is selected from 2,5(6)-bis(aminomethyl)bicyclo[2.2.1]heptane, 1,3, 3-trimethyl-1-(aminomethyl)-5-aminocyclohexane, 1,8-diamine-2,4-dimethyloctane; octohydro-4, 7-methane-1H-indenedimethyl diamine, 1,1′-methylenebis(4-aminocyclohexane), bis(aminomethyl)cyclohexane, 1,3-bis(aminomethyl)cyclohexane, bis(aminomethyl)norbomane, and n-aminoethylpiperazine.

46. The metal primer adhesive component according to claim 39, wherein the aliphatic amine with a benzene ring is selected from 1,4-xylylene diamine (p-xylene diamine) and 1,3-xylylene diamine (m-xylene diamine).

47. The metal primer adhesive component according to claim 39, wherein the second component of the thermosetting bicomponent is polysulfite, preferably a mercaptan.

48. The metal primer adhesive component according to claim 47, wherein the mercaptan is selected from the group consisting of trimethylolpropane tri(3-mercaptopropionate), tris[2-(3-mercaptopropionyloxy)ethyl]isocyanurate, glycol di(3-mercaptopropionate), di-pentaerythritol hexa(3-mercaptopropionate), pentaerythritol tetra(3-mercaptopropionate), ethoxylated trimethyl olpropane(3-mercaptopropionate), polycaprolactone tetra(3-mercaptopropionate), 4-(mercaptomethyl)-3,6-dithia-1,8-octanedithiol, 1,2-bis(2-mercaptoethoxy)ethane, 1,2-bis(mercaptomethyl)-1,3-propanediol, 3-mercapto-2,2-bis(mercaptomethyl-1-propanol, 2,2-bis(mercaptomethyl-1,3-propanethiol and 2-ethyl-2-(mercaptomethyl)-1,3-propanethiol.

49. The metal primer adhesive component according to claim 39, wherein the second component of the thermosetting bicomponent optionally comprises at least a pigment.

50. The metal primer adhesive component according to claim 39, wherein the additive of the second component of the thermosetting bicomponent are thickeners and/or accelerants.

51. The metal primer adhesive component according to claim 39, wherein the thermoplastic monocomponent additive optionally comprises thickener and/or accelerants.

52. The metal primer adhesive component according to claim 39, wherein the functional amino or sulfite resins are epoxy-amine resins produced from the reaction between epoxy resins with polyamines, and epoxy-sulfhydric resins produced from the reaction between epoxy resins with polysulfide/thiols/mercaptan.
